(19) United States
(12) Patent Application Publication
(10) Pub. No.: US 2023/0368041 A1
(43) Pub. Date: Nov. 16, 2023

(54) EVENT TABLES FOR EFFICIENT EXPERIENCE REPLAY

(71) Applicant: Sony Group Corporation, Tokyo (JP)

(72) Inventors: Varun Kompella, Kanata (CA); Thomas Walsh, Melrose, MA (US); Samuel Barrett, Cambridge, MA (US); Peter Wurman, Acton, MA (US); Peter Stone, Austin, TX (US)

(21) Appl. No.: 18/296,795

(22) Filed: Apr. 6, 2023

Related U.S. Application Data
(60) Provisional application No. 63/364,665, filed on May 13, 2022.

(51) Int. Cl. G06N 5/02; G06F 9/54

(52) U.S. Cl. CPC G06N 5/02; G06F 9/542

(57) ABSTRACT

Experience replay (ER) is an important component of many deep reinforcement learning (RL) systems. However, uniform sampling from an ER buffer can lead to slow convergence and unstable asymptotic behaviors. Stratified Sampling from Event Tables (SSET), which partitions an ER buffer into Event Tables, each capturing important subsequences of optimal behavior. A theoretical advantage is proven over the traditional monolithic buffer approach and the combination of SSET with an existing prioritized sampling strategy can further improve learning speed and stability. Empirical results in challenging MiniGrid domains, benchmark RL environments, and a high-fidelity car racing simulator demonstrate the advantages and versatility of SSET over existing ER buffer sampling approaches.

### CROSS-REFERENCE TO RELATED APPLICATIONS

This application claims the benefit of priority of U.S. provisional patent application 63/364,665, filed May 13, 2022, the contents of which are herein incorporated by reference.

### BACKGROUND OF THE INVENTION

### 1. Field of the Invention

Embodiments of the invention relate generally to reinforcement learning methods. More particularly, embodiments of the invention relate to methods and systems for providing a deep reinforcement learning system that uses event tables for efficient experience replay. One implementation can use stratified sampling from event tables (“SSET”), which partitions an experience replay buffer into event tables and samples data from the tables based on a provided distribution. These techniques lead to improvements in learning speed and stability.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many recent deep reinforcement learning (RL) breakthroughs rely on Experience Replay (ER) and the corresponding buffer (an ERB) to store massive amounts of data that is re-sampled during training. Consider, however, a high-frequency car-racing simulator where an agent takes thousands of steps to complete a lap and where crucial events, such as passing another car, may occur on just a few of those steps. Uniform random sampling from an ERB populated with all the lap data is highly unlikely to focus on this key event. Prioritized Experience Replay (PER), which skews sampling based on temporal difference (TD) errors, might do better, but may also focus on states unlikely to be reached by the optimal policy.

Many approaches have been proposed for prioritized ERB sampling. The most widely used is Prioritized Experience Replay (PER), which prioritizes state/actions with the largest TD errors. However, PER does not specifically focus on states aligned with the optimal policy: indeed experiences that have zero TD error under one policy may never be sampled again even after the behavior policy has changed.

In view of the foregoing, there is a need for methods and systems to address these limitations of existing ER methods.

### SUMMARY OF THE INVENTION

To address these limitations of existing ER methods, aspects of the present invention provide event tables, ERB partitions that hold sub-trajectories leading to events, and a corresponding wrapper algorithm, Stratified Sampling from Event Tables (SSET), to build training samples for off-policy RL.

In large domains, simply over-sampling the small number of disconnected state/actions where events occur is unlikely to be beneficial since initial state values would still rely on uniform sampling of the states between event occurrences. Instead, embodiments of the present invention store the finite-length history that preceded the event in the corresponding event table. Intuitively, this data forms a “fast lane” for backups between event occurrences that chains back to the initial state(s). By sampling individual steps from each table, SSET avoids the instability of using temporally correlated data in mini-batches.

Aspects of the present invention provide a theoretical underpinning for the fast-lane intuition and show that, if the events are correlated with optimal behavior and histories are sufficiently long, SSET can dramatically speed up the convergence of off-policy learning compared to using uniform sampling or even PER. Even if those conditions fail, a bias correction term preserves the Bellman target, although convergence may be slowed. From empirical results, these properties translate to different off-policy RL base learners including double deep Q-network (DDQN), soft actor critic (SAC), and the distributional quantile regression-SAC (QR-SAC) algorithm.

While SSET is a new way to optimize sampling from an ERB, it is complementary to many existing prioritization approaches or behavior shaping techniques. Specifically, SSET can be applied based on known events with TD-error PER used within each table, thereby focusing on crucial states that also need value updates.

Aspects of the present invention can apply this “best of both worlds” approach in many experiments and show that it performs better than using only one of the techniques. Similarly, SSET outperforms potential-based reward shaping in empirical experiments, but the combination of two approaches provides both better agent exploration and more efficient backups. Finally, viewing each event table as a data set for a particular skill, SSET can mitigate catastrophic forgetting in RL. Experiments, described in greater detail below, show this advantage in acquiring multiple skills and retaining skills over time.

Aspects of the present invention make several contributions for ER using Event Tables, including (1) Event Tables and the SSET framework is introduces; (2) theoretical guarantees are derived that quantify the sample complexity improvement with properly designed events and provide a bias correction that ensures the Bellman target is preserved; (3) the advantages of SSET over uniform sampling or PER in challenging MiniGrid environments and continuous RL benchmarks is empirically demonstrated, and it was found that combining SSET with TD-error PER or potential-based reward shaping can further improve learning speed; (4) results are provided in the highly-realistic Gran Turismo Sport® race-car simulator where SSET improves learning speed and policy stability.

The importance of sampling along “good” trajectories was explored in classical RL through RTDP and in deep RL. The latter can cause unwanted data correlation in mini-batches. By contrast, SSET does not attempt to use data from the same trajectory in a mini-batch, instead relying on sampling to spread trajectories across many mini-batches, providing both stability and backups along a trajectory. Variants of Topological Experience Replay also attempted to prioritize backups along a trajectory using a graph embedding originating from goal states. By contrast, SSET does not require goal states or a discrete state embedding.

Event Tables generalize the ideas explored in several “multi-table” partitioning schemes for ERB s. For example, different tables are used to store high (or high and low) reward transitions separately from common transitions and stratified sampling is used to construct mini-batches. By contrast, SSET allows for any state-based event to partition the ERB, and more importantly, stores trajectories that led to events, not just the events themselves, which is beneficial to ensure the sample complexity guarantees.

SSET can use prior knowledge to ensure a focus on key areas of the state space and therefore has connections to initial state selection and potential-based reward shaping. As described below, SSET can outperform reward shaping on comparable states, and it can be demonstrated that SSET and reward shaping can be used together to improve exploration (shaping) and focus value function backups (Event Tables).

Embodiments of the present invention provide a computer-implemented method comprising partitioning an experience replay buffer for a reinforcement learning agent into event tables based on event conditions and history lengths, wherein each table contains data where a corresponding event condition was true or states that preceded the corresponding event condition within the given history length.

In some embodiments, the experience replay buffer includes a default table that holds all incoming data.

In some embodiments, the event conditions are based on histories and not just a single state.

In some embodiments, each event table has a specified capacity in the experience replay buffer proportional to an overall size of the experience replay buffer.

In some embodiments, each table has a specified sampling probability.

In some embodiments, a mapping from the event conditions to the event tables is surjective, with multiple ones of the event conditions funneling data into the same one of the event tables.

In some embodiments, the event conditions represent a handling or manipulation of objects by an artificial agent.

In a car racing simulator embodiment, the event conditions are based on drafting in a car's slipstream, winning a race, recovering from going off-course, and racing incidents.

In a continuous control problems embodiment that already have rich reward signals, event conditions are based on exceeding thresholds in immediate rewards from a state.

In some embodiments, at least some of the event conditions are suboptimal and designed to help the artificial agent retain memory of, and avoid, adverse outcomes.

Embodiments of the present invention provide a computer-implemented method comprising partitioning an experience replay buffer for a reinforcement learning agent into event tables based on event conditions and history lengths; and permitting stratified sampling from the event tables (SSET) for utilizing the event tables with a reinforcement learning system.

In some embodiments, the method further includes blocking sampling from one of the event tables until it has sufficient data.

In some embodiments, the method further includes determining a bias correction term for stochastic environments.

In some embodiments, the method further includes applying a prioritization scheme inside each of the event tables while sampling.

In some embodiments, the method further includes multi-task training to balance gradient updates to respect data from each of the event tables.

Embodiments of the present invention provide a method of partitioning an experience replay buffer for a reinforcement learning agent comprising determining at least one event condition; determining at least one preceding state indicating a state preceding the event condition within a history length; and partitioning the experience replay buffer into at least one event table based on the at least one event condition and the history length, wherein each event table contains data where a corresponding event condition was true or a preceding state.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an example MiniGrid domain with event conditions for reaching the goal or a gap between rooms, where blue squares indicate the “fast lane” of states that can be over-sampled because they appear in both the event tables and the default table and grey states appear only in the default table;

FIGS. 2A through 2E illustrate three room grid world statistical results from randomly seeded runs (mean shown using solid lines and std-error using shaded regions), where FIG. 2A shows the environment, FIG. 2B shows learned target Q-values summed across the entire state-action space vs training epoch, where SSET Q-values converge with a significantly low std-error, FIG. 2C shows episode return vs training epoch, and FIGS. 2D and 2E show results with TD-error prioritized sampling;

FIGS. 3A through 3C illustrate a comparison with intermediate shaping rewards, showing results from 30 randomly seeded runs comparing SSET against using intermediate shaping reward at the gap where FIG. 3A shows the environment, FIG. 3B shows learned target Q-values summed across the entire state-action space vs training epoch, and FIG. 3C shows episode return vs training epoch;

FIGS. 4A through 4C illustrate SSET performance with ideal and less-ideal event-conditions where FIG. 4A shows the environment, FIG. 4B shows comparisons of different potential-based reward shaping functions with uniform ER to use as baselines, and FIG. 4C shows SSET's performance of ideal and less-ideal event conditions along with baselines (Uniform ER with the best shaping function and with no shaping rewards);

FIGS. 5A through 5E illustrate SSET performance vs default-buffer sampling weight with statistical means of episodic-return from 30 randomly seeded runs for different values of η0 and different event-conditions, where experiments with good conditions (gap_goal, only_goal) are least affected by the changes in η0 and The experiment with the mediocre condition (near_goal) seems to benefit from fine-tuning (best at 0.7), and the experiments with bad conditions (near_initial, only_gap) suffer due to under-sampling the default buffer;

FIGS. 6A through 6E illustrate obstacle course results from 30 randomly seeded runs (mean shown using solid lines and std-error using shaded regions), where FIG. 6A shows an environment with spikes, lava, colored keys and locked doors, where FIG. 6B shows learned target Q-values averaged over agent trajectories vs training epoch, FIG. 6C shows episodic return vs training epoch, and FIGS. 6D and 6e shows results with TD-error prioritized sampling;

FIGS. 7A through 7F illustrate randomized skill environment statistical results from 30 randomly seeded runs (mean shown using solid lines and std-error using shaded regions), where FIGS. 7A through 7C show instances of randomly sampled object configurations, and FIGS. 7D through 7F show episodic return for each skill during the course of training;

FIGS. 8A and 8B illustrate an evaluation result of a slightly shifted initial position test-time performance of the agent starting from a slightly shifted initial grid position (1, 4), where FIG. 8A shows the environment instance, and FIG. 8B shows the number of successful episodes out of 30 seeded runs of the experiment for each evaluation checkpoint;

FIG. 9 illustrates episodic return from 30 randomly seeded runs (mean shown using solid lines and std-error using shaded regions) in the obstacle course environment comparing SSET with intermediate events like, pickup-key, at-door, and the like, against only using a done-conditioned event with different history lengths;

FIG. 10 illustrates episodic return from 30 randomly seeded runs (mean shown using solid lines and std-error using shaded regions) in the obstacle course environment comparing different sampling weights ηi keeping the default table's sampling weight fixed η0=0.5;

FIGS. 11A through 11C illustrate CAGrad with SSET statistical results for different values of CAGrad's coefficient of regularization c∈[0, 1) from 30 randomly seeded runs (mean shown using solid lines and std-error using shaded regions), where higher values of c boost early performance but result in a lower asymptote;

FIGS. 12A through 12E illustrate the statistical mean and standard errors of empirical returns computed from 30 randomly seeded episodes evaluated at different epochs during training;

FIGS. 13A through 13D illustrate the average episodic return (with std-error shown using the shaded regions) during the course of training computed from 30 random seeded runs;

FIG. 14A illustrates cumulative wins evaluated every 5 epochs in the slingshot passing test, where uniform sampling shows high variance while SSET with a slipstream (0.7) event and a “won” event consistently has sample complexity on par with the best uniform-sampling run;

FIG. 14B illustrates the average (and std dev) of winning margins (excluding losses) in the last 100 epochs for each run, where, while one uniform ERB run did best, on average (dashed lines) SSET has the consistently better performance;

FIG. 15A illustrates cumulative wins evaluated every 5 epochs in the slingshot passing test with a threshold of 0.1 (almost any slipstream effect), where uniform sampling shows high variance while SSET with a slipstream (0.1) event and a “won” event has better variance but overall performance is not as good as the results in the main text with a 0.7 threshold;

FIG. 15B illustrates the average (and std dev) of winning margins (excluding losses) in the last 100 epochs for each run;

FIG. 16A illustrates the cumulative wins evaluated every 5 epochs in the slingshot passing test with a threshold of 0.9 (only counting slipstream from a very close opponent), where, in this case, the difficulty of finding states with >0.9 slipstream leads to higher variance, but not as high as uniform sampling;

FIG. 16B illustrates the average (and std dev) of winning margins (excluding losses) in the last 100 epochs for each run;

FIG. 17A illustrates cumulative times an agent went off-course in 3-lap evaluations performed every 5 epochs, where uniform sampling runs (red lines) display catastrophic forgetting, oscillating between steady laps and policies that take risks and go off course, where SSET converges to policies that more consistently stay on course (flatter blue lines);

FIG. 17B illustrates the summary statistics on converged behavior, where the worst SSET run stays on course more than the best uniform one, with comparable lap times;

FIG. 18 illustrates the concept of event tables from a storage perspective, where, when an artificial agent encounters an “event”, the agent's history going back for tau timesteps is stored in a specific table, where a “default” table contains duplicates of this event data as well as any data not associated with an event or its corresponding history, where each table has a fixed proportion, kappa, of the overall buffer; and

FIG. 19 illustrates the concept of event tables from a sampling perspective, where a learning algorithm samples mini-batches of data from the tables based on fixed proportions (eta) as long as the table has sufficient data (governed by parameter d).

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G, and the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide Stratified Sampling from Event Tables (SSET), which partitions an experience replay (ER) buffer into Event Tables, each capturing important subsequences of optimal behavior. ER is an important component of many deep reinforcement learning (RL) systems. However, uniform sampling from an ER buffer can lead to slow convergence and unstable asymptotic behaviors. A theoretical advantage is proven over the traditional monolithic buffer approach and the combination of SSET with an existing prioritized sampling strategy can further improve learning speed and stability. Empirical results in challenging MiniGrid domains, benchmark RL environments, and a high-fidelity car racing simulator demonstrate the advantages and versatility of SSET over existing ER buffer sampling approaches.

In the below description, references to various algorithms, propositions, definitions and lemmas are provided at the end of the description.

### Terminology

Following standard definitions, a reinforcement learning agent is considered acting in an episodic Markov Decision Process M= [symbol] S, A, R, P, γ, I, β [symbol] with state space S, action space A, reward function R:S, A→Pr[ [symbol] ], transition kernel P:S, A→Pr[S], discount factor γ∈[0, 1), initial state distribution I:Pr[S], and episode termination function β:S→{0, 1}. At time step t, the agent uses its current behavior policy πₜ:S Pr[A] to select an action and then observes the reward rₜ≠R(sₜ, aₜ) and next state s′ ˜P(sₜ, aₜ). If β(s′)=1 or a horizon of T is reached, then the episode ends. The value function of a policy is defined by its long-term discounted return: Q^{π}(s, a)=R(s, a)+γE_{s′˜P(s,a)}[V^{π}(s′)], where V^{π}(s)=Q^{π}(s, π(s)). The agent is tasked with finding an optimal policy π* and the corresponding Q*(s, a) that maximizes the expected discounted return. Aspects of the present invention focus on model-free off-policy methods that learn Q*(s, a) directly from data through incremental updates, such as Q-learning's gradient-style update to the current value function Qₖ(s, a): Qₖ₊₁(s, a)=(1−α)Qₖ(s, a)+αδ with learning rate α∈(0, 1] and temporal difference (TD)−error δ=r(s, a)+γVₖ(s′)−Qₖ(s, a) for Vₖ(s′)=max_{a′}Qₖ(s′, a′).

In deep reinforcement learning, S is typically continuous and high dimensional, so the value function and (sometimes) policy are represented by neural networks with parameters θᵢₖ for each network i. To update the value networks, model-free deep RL algorithms like DDQN make updates to Q(s, a|θₖ) along the gradient of the TD-error. To improve stability, deep RL methods typically utilize a fixed target network for computing Vₖ(s′) that is only updated after a batch of updates.

Experience replay is a technique used in off-policy RL to improve sample efficiency by performing gradient updates based on many experience tuples [symbol] s, a, r, s′ [symbol] stored in an ERB. In the deep learning case, the ERB often stores tens or hundreds of millions of tuples with mini-batches sampled from the buffer and then used in gradient updates to θᵢₖ.

An event specification (event spec) can be defined: v= [symbol] ω, τ [symbol] , composed of a (Boolean) event condition over states ω: S→{0, 1} and a history length τ. It can be said that an event occurs in state s if ω(s) is true. Aspects of the present invention can assume event conditions are specified by domain experts or RL practitioners; where aspects of the present invention can provide guidance on selecting a default set of useful event conditions, as discussed in greater detail below. It can be proven that event conditions that are true only in states that are visited more often by the optimal policy than the behavior collection policy yield sample efficiency gains when paired with sufficiently long histories. Terminal goal states, high reward states, bottleneck states, or important rare states (e.g., passing another car) are all strong candidates. To avoid under-sampling any crucial states, histories τ can be long enough (in expectation) to reach back to a previous event occurrence, an initial state, or the horizon and chain together from I to the optimal policy's final state(s). Finally, outside of the core theory, when using function approximation, negatively rewarding states that are not often encountered by the optimal policy may be useful event conditions to avoid catastrophic forgetting of these possible outcomes from nearby states.

Stratified Sampling from Event Tables

A Stratified Sampling from Event Tables (SSET) algorithm is shown as Algorithm 1, below. Given n event specs {vᵢ|i∈[1, n]}, the ERB is partitioned into n event tables, B^{vi} and a “default” table B⁰. Each B^{vi} holds only time steps where ωᵢ(s′) was true or steps preceding the event occurrence in the τᵢ-length history. The default table B⁰ holds all time steps, including those with event occurrences. Data is inserted into each table in a FIFO manner with table capacities governed by parameter and later used to construct training data for an off-policy RL algorithm A.

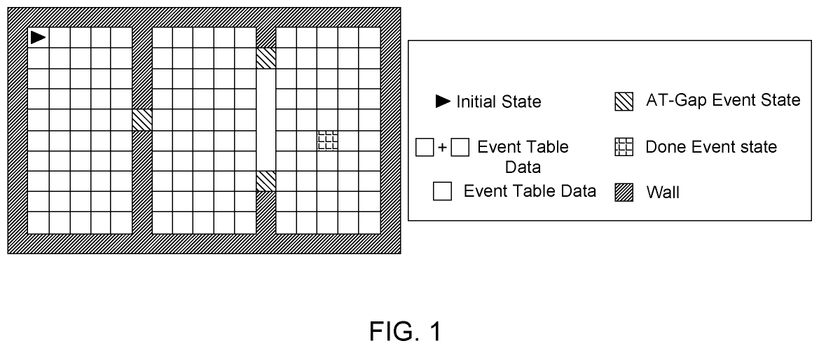

On each agent step in SSET, experience [symbol] sₜ, aₜ, rₜ, sₜ₊₁ [symbol] is stored in B⁰ as well as an ephemeral buffer E for the current episode (line 11). If ωᵢ(sₜ₊₁) is true (line 13), the experience and all the τᵢ steps preceding the event that were not already sent to B^{vi} are added there as well. Intuitively, each table contains data necessary to train the value function in the area approaching an event occurrence and chain together to form a “fast lane” (see FIG. 1) for backups that will be over-sampled compared to monolithic ER. For simplicity Algorithm 1 assumes each event spec maps to a unique table (lines 4 and 14) but the mapping could also be surjective. Note that the (potentially overlapping) data stored in these tables can be managed efficiently by ERB implementations.

When mini-batches are constructed (line 18), fixed, independent and identically distributed proportions are collected from each table using probabilities Ili, for i∈[0, n]. To prevent early over-fitting, minimal data requirements (based on the minibatch size) can be applied, with proportions normalized appropriately if one or more tables has insufficient data.

Like PER and other ERB prioritization schemes, SSET can introduce bias in stochastic environments. In the extreme case, if P(s, a) has equal probability for two terminal states s₁ and s₂ but only ω(s₁) is true, then sampling from the event table will skew the data distribution higher for s₁ outcomes. To alleviate this error, line 19 of Algorithm 1 applies a weighted correction derived in Lemma 2. The full correction term applies a weight based on the probability of [symbol] s, a [symbol] not being in each event table, which can be computed in discrete domains by counting the number of times a (s, a) pair was not part of any event history. For continuous domains, a priority sum tree data-structure could be used, similarly to PER, by setting priorities for samples in the event buffer equal to (1+η) and samples outside to (1−η). The correction weights for each transition inside the event tables would be priority-sum 1+η. However, this approach is aggressive and might slow down learning, as seen in PER. It should be noted that, for deterministic MDPs, the correction is not needed. In environments without non-goal terminal states, increasing τ may mitigate some bias by storing more non-event outcomes in the event table. According to mildly stochastic empirical studies, this longer τ approach can be used.

Intuitively, the theorem states that SSET, using event conditions that are correlated with an optimal policy and histories that are sufficiently long, will have sample complexity N^{B}^{^{v}}^{∪B}^{⁰}, K for learning Q*(s, a) in the necessary part of the state space (S^{f}), and N^{B}^{^{v}}^{∪B}^{⁰}, K is (with high probability) smaller than the sample complexity of learning with a monolithic buffer of the same size.

Algorithm 1: SSET: Stratified Sampling from Event Tables

| | |
|---|---|
| 1 | • νᵢ = (ωᵢ, τᵢ) ∀i ∈ [1, n]: event conditions and their corresponding history lengths |
| 2 | • (ηᵢ, κᵢ, dᵢ) ∀i ∈ [0, n]: sampling probabilities, capacity sizes, and minimum data |

requirements

| | |
|---|---|
| 3 | • A, π^{b}, T − Off-policy RL algorithm, behavior policy and episode length |
| 4 | B⁰ ← [ ](κ₀), B^{νi} ← [ ](κᵢ) ∀i ∈ [1, n], |
| 5 | for episode k = 1 to ∞ do |
| 6 | E ← [ ] // init episode buffer |
| 7 | for t = 0 to T − 1 (or episode termination) do |
| 8 | s ← current state observation |
| 9 | execute action a sampled from π^{b}(s) |
| 10 | observe r and next state s′ |
| 11 | store transition (s, a, r, s′) in B⁰ and E |
| 12 | for i = 1 to n do |
| | //update event tables |
| 13 | if ωi(s′) then |
| 14 | store last τⁱ transitions [E_{t-τi+1}, ...,Eₜ] in B^{νi} |
| 15 | end |
| 16 | end |
| 17 | end |
| 18 | D ~ B⁰ ∪ᵢ B^{vi} , ∀i s.t. \|B^{νi} \| ≥ dᵢ //sample & concat i.i.d. minibatches |
| 19 | Update weights for bias correction using E // (Lemma 2) |
| 20 | Update critic and policy networks using A and D |
| 21 | end |

Theorem 1. Let S^{f}={s|P(Γₛ^{π*}, ⊂B^{v})≥p̅} denote the set of states such that the sampled optimal trajectories (Γ^{π*}; Def. 2) starting from those states are contained in the combined event-buffer with a probability greater than p̅∈(0, 1], and η=Σᵢ₌₁ⁿηᵢ. Under the conditions of Prop. 1 and using μ as defined in Lemma 1 if τ∀I∈[1,n]≤((1−η)^{m}/(m+1)_{nμ}), then at iteration K of Q-learning with a target function:

p(N^{B}^{^{v}}^{∪B}^{⁰}^{,K}≤(1−η)^{2m}N^{B,K})≥p̅,∀s∈S^{f},m∈ [symbol] ⁰⁺.

Proof sketch. By making use of lower bounds on the convergence rate of tabular Q-learning with a target function (see Algorithm 2), the state probability distribution (density) can be defined following a given policy to a finite horizon from an initial state and the state probability distribution can be used to define the state density disparity to the optimal policy. Then, event conditions can be formally defined on the states with low optimal policy disparity or final states of the optimal policy. This definition can be extended to event sections and their corresponding tables that include sufficient history to (on expectation) reach back to a previous event or initial state. One can then quantify (Lemma 1) the over-sampling of experience in the event tables can be quantified (Lemma 1) and the convergence rate can be derived (Prop. 3) and the bias correction procedure (Lemma 2) can be derived. Finally, the resulting convergence bound is shown to be an improvement over uniform sampling.

### MiniGrid Experiments

Experimental validation of SSET is now provided in environments from the MiniGrid domain using the DDQN RL algorithm. A dense neural net architecture with hidden layers is used to encode the Q-functions and an E-greedy behavior policy for collecting data. In each experiment, SSET demonstrates improvements in sample complexity or decreased variance against uniform experience replay (Uniform ER), an off-policy version of an (on-policy) reverse sweep of updates from the goal (Reverse-sweep*; in the spirit of episodic backward update (EBU)), and TD-error prioritized experience replay (PER).

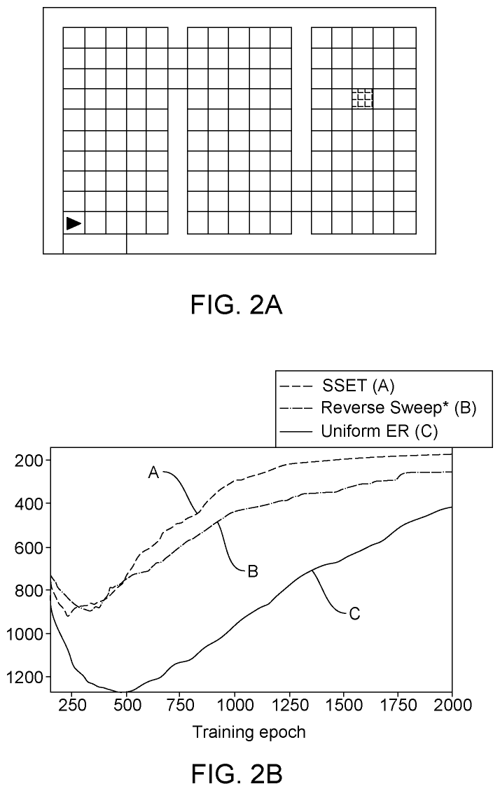

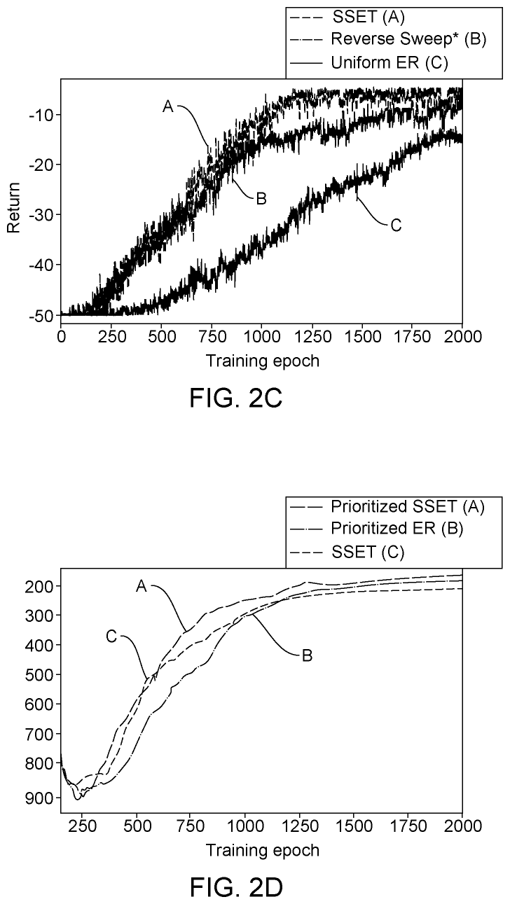

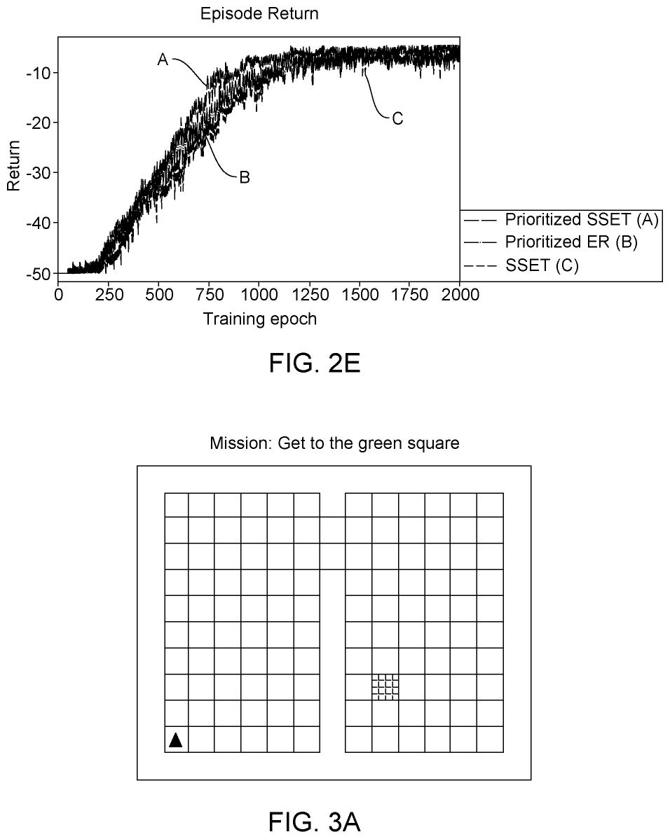

Proof of Concept: Three Room Grid World. It is first demonstrated the sample complexity speedup of SSET in a three-room world (see, FIG. 2A). The agent's observation is its 3D grid position and orientation (x, y, θ) and its available actions are turn-left, turn-right and forward. The rewards are +1 at the green square and −0.1 otherwise. Two event conditions are used for SSET with a history length of 200: one that occurs at any gap state between two rooms, and another that occurs at the green square. FIGS. 2B and 2C show the mean and standard error (from 30 randomly initialized runs) of the learned Q-values summed across the entire state-action space and the resulting episodic return during the course of training. SSET performs best in terms of both sample efficiency and learning stability (lower variance between runs). The result against a reverse-sweep approach demonstrates the utility of the intermediate gap events, which serve as waypoints for the backups. FIGS. 2D and 2E compare SSET to PER and a combination of the two. PER speeds up learning compared to uniform sampling, but with considerably more variance across seeds than SSET, possibly due to overestimation bias. Combining SSET with TD-error prioritization yields the best of both worlds: providing reliable local Bellman target estimates and prioritizing samples with high error to those targets.

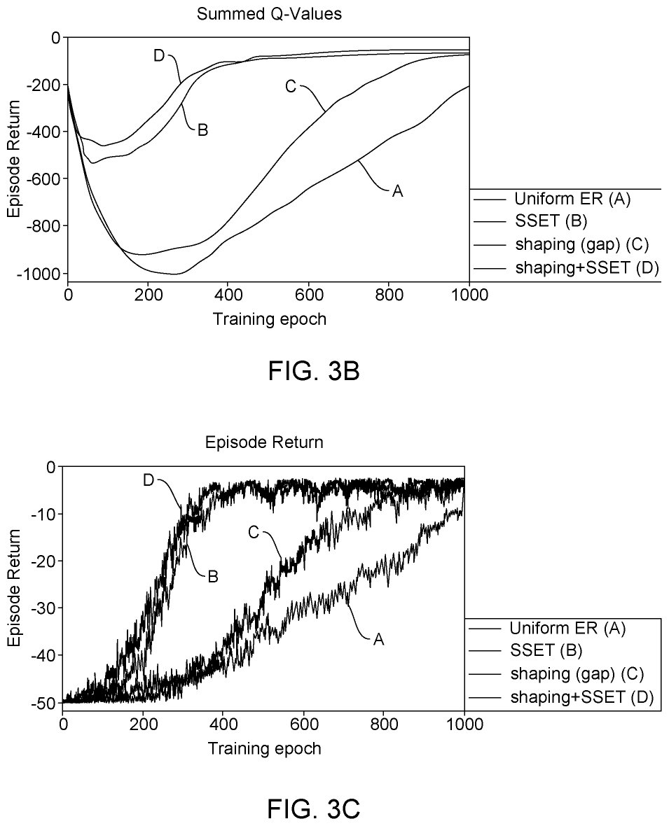

Comparison with Shaping Rewards. Potential-based shaping (PBS) provides a framework for adding rewards to speed up learning without affecting the optimal policy. Similar to PBS, SSET preserves optimality while providing an effective way to infuse domain knowledge. Here, the performance of SSET and reward shaping are compared, as well as their combination, in a grid-world domain similar to the previous experiment (see FIG. 3A). A shaping potential with ϕ(s)=1 at the gap and 0 elsewhere is used to provide a reward component of (γϕ(s′)−ϕ(s)) in addition to the environmental (goal) reward. SSET uses events that occur at the gap and the goal. FIGS. 3B and 3C show SSET outperforms both shaping and the no-shaping baseline. While reward shaping acts as a heuristic to speed up exploration, those rewards still need to be bootstrapped back to the initial states, which is the forte of SSET. Thus, when the two are combined, even better performance is realized as shaping guides exploration and SSET provides a “fast lane” to bootstrap the values. Comparisons to less ideal potential shaping functions and ablations of the η₀ parameter for SSET in this domain are discussed below.

SSET Performance with Badly Designed Event Conditions. Based on the formal definition of event conditions (Def. 4), good events occur in states that are aligned along optimal trajectories. It is assumed that such event conditions are typically specified by domain experts or RL practitioners. In this section, the performance of SSET is evaluated when the event conditions are badly designed and this is compared against good conditions, along with other baselines such as uniform ER with different potential reward-shaping functions. Finally, is was studied how performance varies with changes to the default buffer's sampling probability (go).

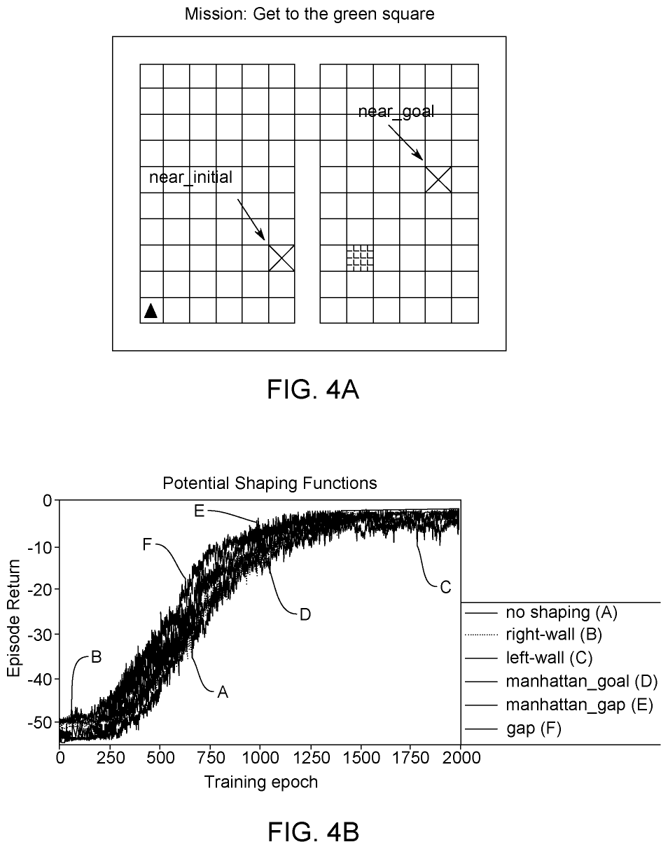

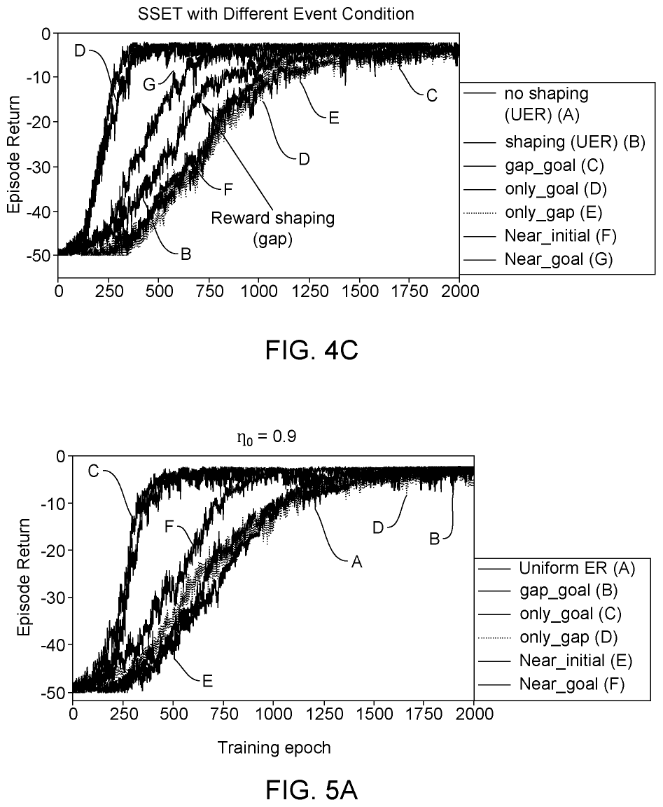

FIG. 4A shows results from the 2D grid world domain used in the reward shaping comparisons. The task is to get to the destination square starting from an initial bottom-left grid position, which requires navigating through the gap between the rooms. Several potential reward-shaping functions were compared to pick a good baseline. FIG. 4B shows the statistical means (computed from 30 randomly seeded runs) of episodic-return during training using different potential shaping functions: gap (+1 at the gap grid position and zero everywhere), manhattan_goal (normalized manhattan distance between agent's position and the goal), manhattan_gap (distance to the gap), right-wall (normalized x-distance to the right boundary wall), left-wall (normalized x-distance to the left boundary wall) and no-shaping. Not surprisingly, the best performing shaping function is the “gap” function, which motivates the agent to get to the gap first. Others perform either similar or subpar to the experiment with no-shaping rewards.

Next, SSET performance was compared for different event conditions and η₀ 0.7: two conditions (based on Def. 4) that trigger at the goal and gap (gap_goal), or goal alone (only_goal) with a sufficient history length (τ=30). Three less-ideal conditions were selected that occur at positions near the goal (near_goal), at the gap (only_gap) and near the initial position (near_initial), respectively. FIG. 4C shows statistical means of the corresponding experiments along with the baselines of shaping (using the gap potential function) and uniform ER with no shaping. The plot shows that there is a significant improvement in learning efficiency for experiments using the well-defined events. The performance of SSET of near_goal event condition is not ideal, but still much better than the best shaping baseline. Experiments with only_gap and near_initial conditions perform similar to the Uniform ER (no-shaping) as learning relies significantly on transitions in the default buffer to bootstrap the value from the rewarding states (goal reward in this case) to the states where the events occur. Based on these results, it was concluded that both reward shaping and event tables show degradation when using poorly chosen shaping functions or event conditions but that even with poorly chosen events SSET often outperforms reward shaping in this domain.

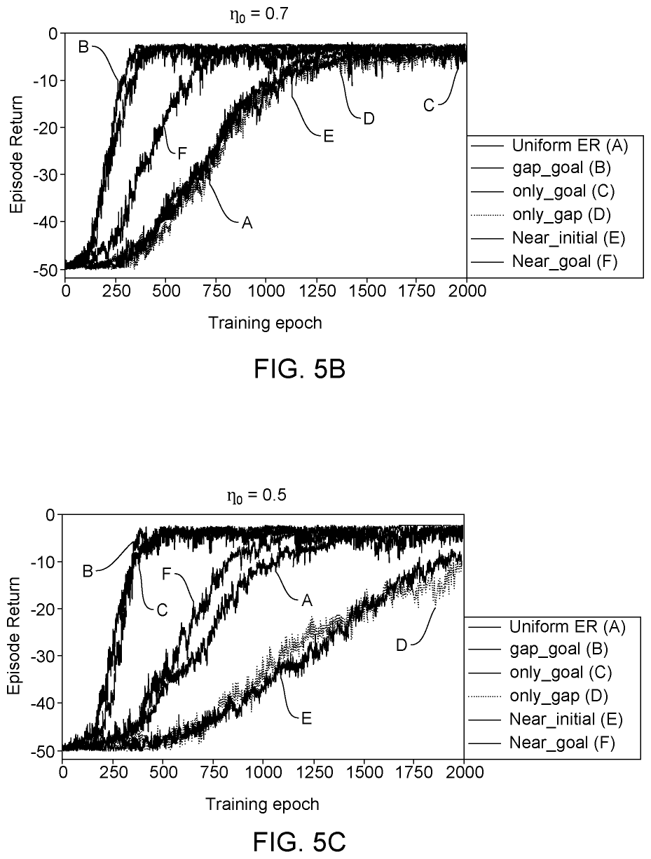

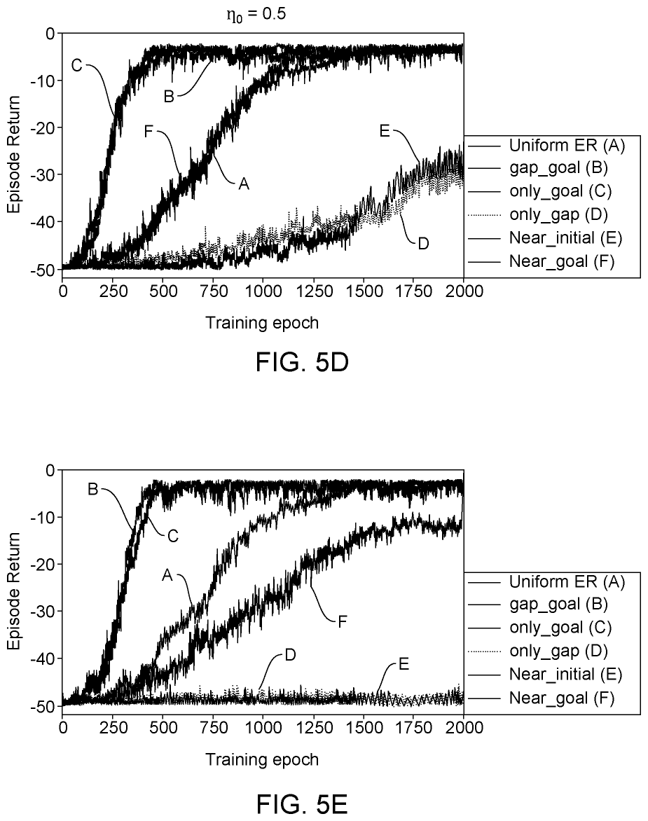

Next, it was compared how SSET's performance varies with default-buffer's sampling probability (see FIGS. 5A through 5E). The plots show that experiments with good conditions are least affected by the changes in η₀. The experiment with the mediocre condition (near_goal) seems to benefit from fine-tuning (best at 0.7), and the experiments with bad conditions suffer (η₀<0.7) due to under-sampling the default buffer. For all practical purposes, it is recommend using higher values for 110 unless the event conditions are carefully designed.

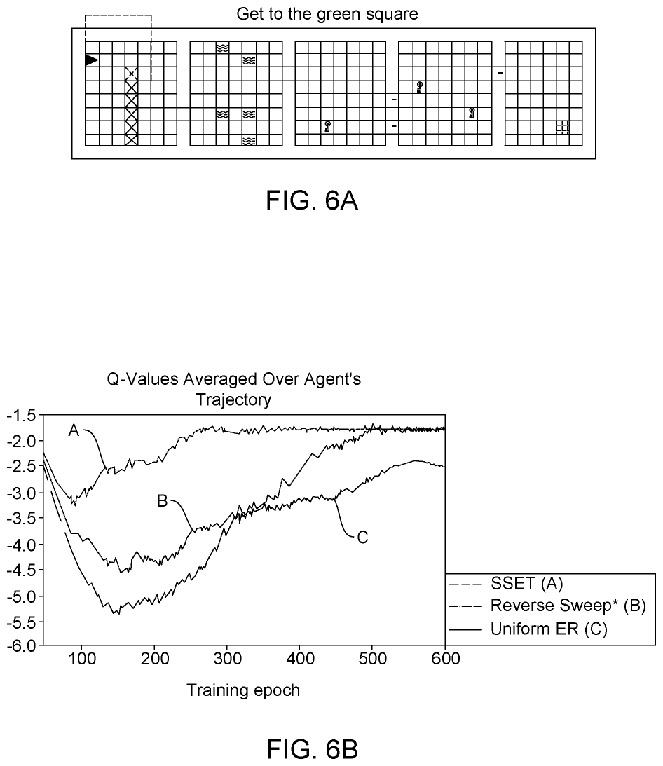

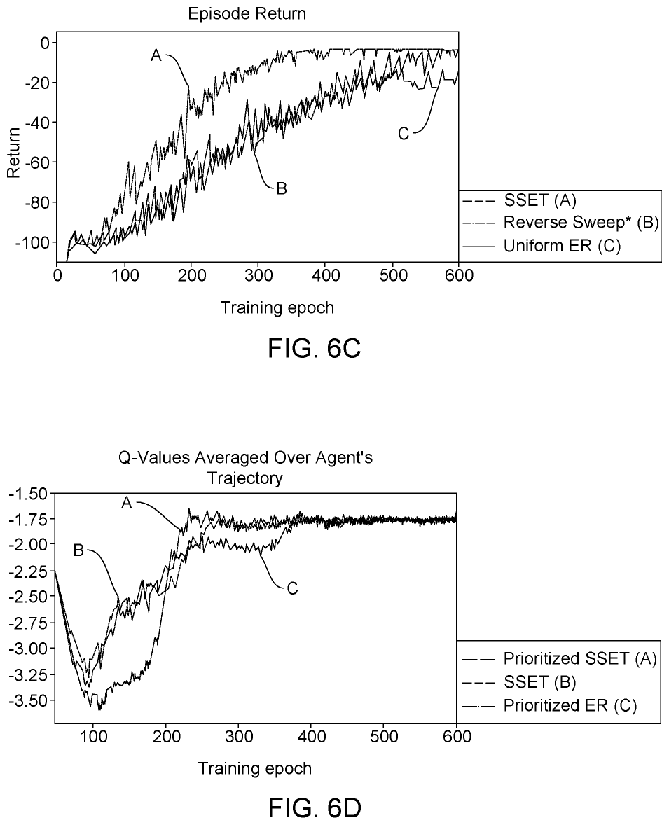

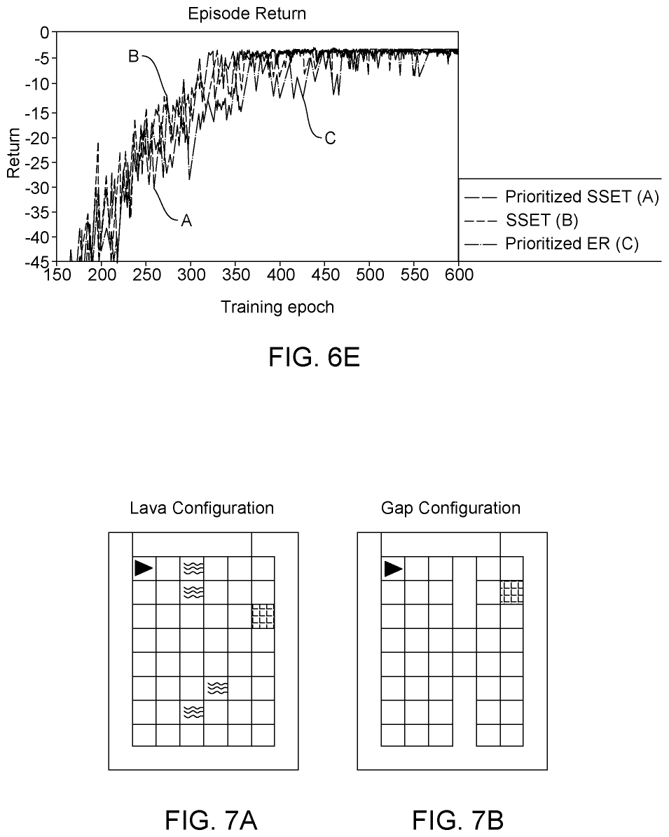

Obstacle Course and Randomized Skill Environment. The more complex obstacle course environment includes multiple sections (see FIG. 6A) containing spikes with −1 reward (yellow squares), lava with −1 reward and episode termination (orange squares), and colored keys to open doors. The exact positions of lava, gaps in the walls, keys, doors, and key/door colors are randomly set in each episode but the ordering of the rooms is fixed (e.g., the spikes are always in the first room). The agent's task is to get to the green square starting from the top-left corner. The agent's observation include (a) an egocentric 5×5 localized forward-view image that encodes a representation of obstacles around it, (b) a Boolean indicator for carrying an object, (c) a 2D representation (category, color) of the object it is carrying, otherwise (−1,−1), and (d) 3D grid position and orientation (x, y, θ). The agent's action space includes 3 additional actions (pickup key, drop key, toggle door). Event conditions are used with a history length of 50 associated with each obstacle category (e.g., picked-up-a-key, opened-a-door, and the like). FIGS. 6B and 6C clearly illustrates the improved efficiency and stability of using event-tables over reverse-sweep and uniform ER. In comparison to TD-error prioritization (FIGS. 6D and 6E), again PER exhibits more variance across multiple seeded runs. Interestingly, in this domain, SSET performs equally well with or without additional TD-error prioritization.

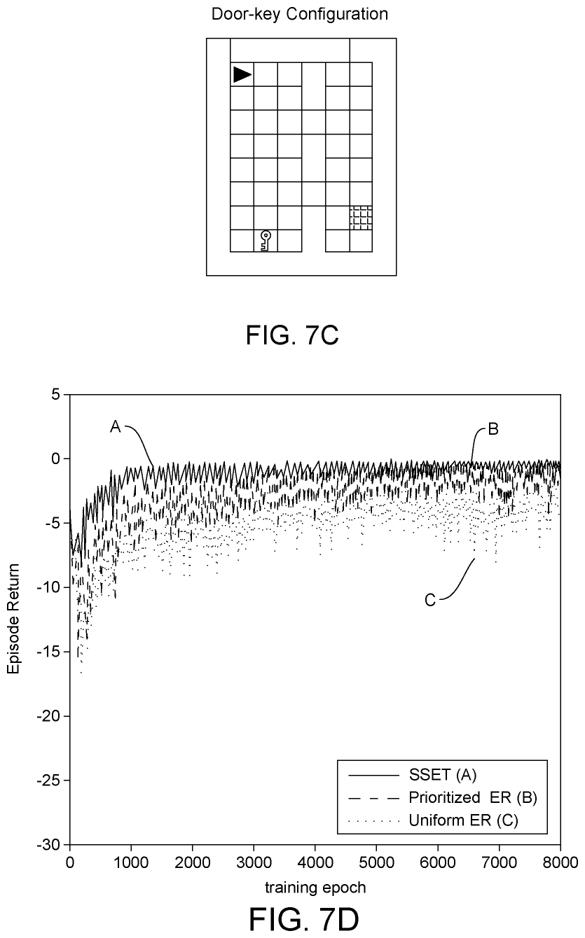

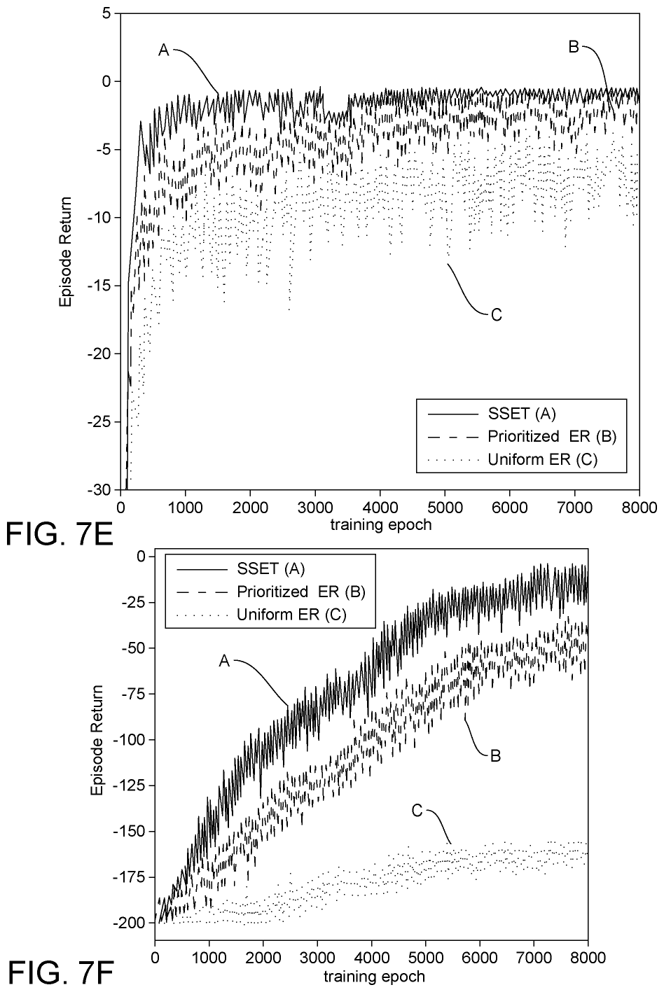

Finally, a randomized multi-skill setup was considered where the agent must either avoid lava, go through a gap, or open the correct door to reach the goal (FIGS. 7A through 7C). The scenario (lava, gap, or open-door) and object positions/colors are sampled randomly for each training episode. This is a more challenging task than the obstacle course above because object locations don't follow a fixed sequential pattern. A square that contains a door in one episode may contain lava in the next one. Using uniform ER, value function learning is dominated by the easier skills (lava, gap) and the agent fails to acquire the difficult open-door skill. Learning using SSET performs much better, acquiring and maintaining all the skills compared to uniform sampling and even PER.

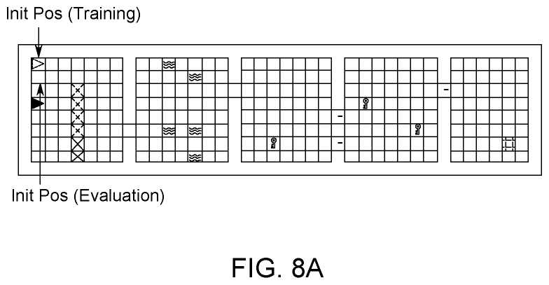

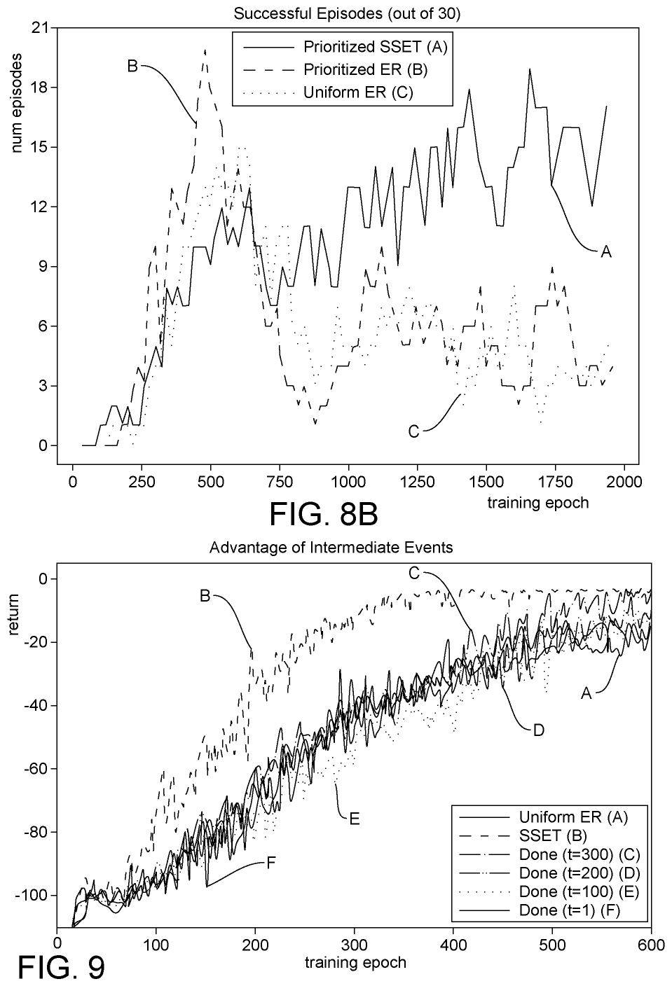

Catastrophic Forgetting in Obstacle Course. Here, it is illustrate how SSET avoids catastrophic forgetting that hampers even PER during extended learning in the obstacle course experiment presented above. At the end of each episode during training, the agent is always reset to the top-left corner (1, 1) of the environment. At a frequency of every 20 epochs during training, the performance of the agent was evaluated starting from a slightly shifted initial grid position (1, 4) as shown in FIG. 8A. FIG. 8B shows the number of successful episodes over the 30 seeded runs of the experiment for each evaluation checkpoint. An episode is considered successful if the agent is able to navigate through the obstacles and reach the green square. The plot shows that the agents with both uniform and TD-error prioritized experience replay learn how to complete the task early on, but forget the skill as the training continues. It was hypothesized that due to changing epsilon-greedy behavior policy, the Q-function updating with samples from a standard FIFO uniform (and even prioritized) replay buffer, quickly begins to over-fit trajectories starting from (1, 1) avoiding the nearby negative rewarding spikes. Over-fitting on these trajectories potentially leads to losing previously learned estimates for nearby transitions. On the other hand, with SSET and sampling from the at-spike event table that is unaffected by the updating behavior policy, the agent continues to improve its value estimates for those transitions over time resulting in a better behavior.

In the context of this particular experiment and similar RL domains, having robust performance against perturbations is not typically expected and therefore catastrophic forgetting may not be a serious issue. However, it becomes a challenging issue to tackle in realistic domains like racing games, such as Gran Turismo®, where the training and testing distributions can be different or the domain is simply so large that one can forget low probability events, like leaving the course, as described below.

Intermediate Events, Histories, and Sampling Weights. The proof of Theorem 1 shows that SSET improves sample complexity along transitions from the optimal trajectory that are, with high probability, stored in the Event Tables. This probability can be increased by either increasing the number of event conditioned tables n with short histories or having fewer tables with longer histories τᵢ. However, the proof of Lemma 1 shows the latter is not as effective, especially in early learning when the histories leading to a far-off event may contain many sub-optimal actions, diluting the impact of that table until the policy is better optimized. Instead, when possible, it is best to have many events acting as waypoints in the environment as shown in FIG. 1. An empirical test is now presented, supporting this insight in the sparse-reward obstacle course environment presented above. The test doubles as a comparison to methods that partition an ERB based solely on reward conditions without corresponding histories.

SSET is compared with the intermediate events used above (pickup-key, at-door, and the like), each with a history length of 50 against only using a terminal rewarding event with different history lengths. FIG. 9 shows the statistical average curves of episodic return during the course of training computed from 30 random seeded runs. It is clear from the result that SSET with intermediate events outperforms the rest. Intuitively, intermediate events can be seen as waypoints on the fast lane for TD backups to the initial states, thereby improving the overall sample efficiency. The plot also highlights that just sampling terminal goal states (as in speech-emotion recognition (SER), τ=1 in the chart) or transition sequences leading to them (as in teach by reinforcements (TER), EBU or Reverse-Sweep*, higher τ values) may not be sufficient to achieve improved efficiency in a sparse reward setting like the Obstacle Course.

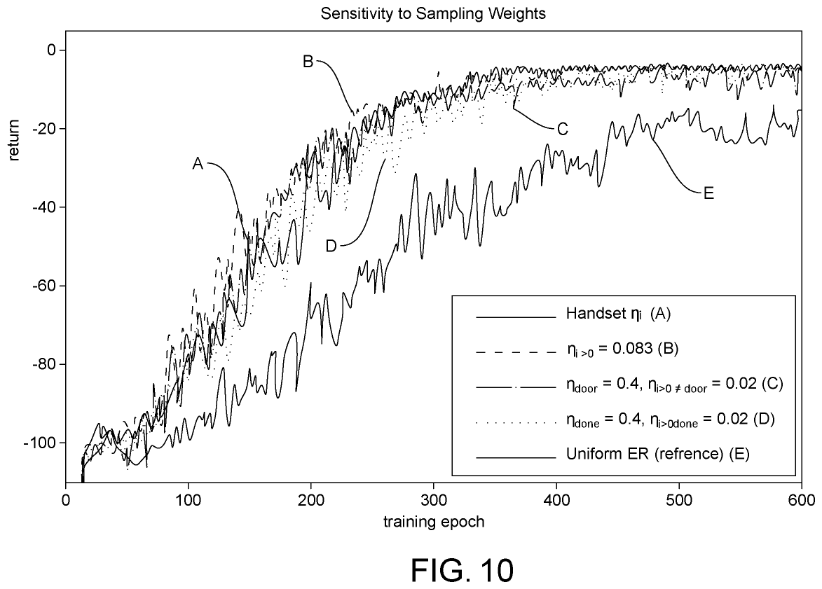

Finally, in FIG. 10, SSET performance is compared for different sampling weights ηᵢ keeping the default table's sampling weight fixed (110=0.5). Handset ηᵢ are η^{I>0}=0.5/6=0.083 are weights distributed equally across the six event tables, η_{door}=0.4 assigns a large weight to the door event table and η_{done}=0.4 assigns a large weight to the done table. The sampling is done such that there is at least one sample picked from each table. The results show that the performance is similar with the extreme sets showing some minor fluctuations at the end, but still performing better compared to using uniform experience replay. A general recommendation is to start with using equal weights across all events tables and if needed tuning them further to get a peak performance.

Conflict Averse Gradient Descent with SSET. Most temporal-difference RL algorithms, like Q-learning, rely on minimizing Bellman errors to local target estimates. With an increasing number of outer iterations, these local targets inch closer to the true global target Q*, thereby optimizing the RL objective asymptotically. During early training, stratified mini-batch sampling from event tables could result in local gradients that may conflict with each other. Using a standard average gradient descent approach, like SGD, might not be beneficial for uncommon or difficult-to-learn events as the average gradient would be skewed in the direction of the easier events. For example, in the randomized multi-skill experiment presented above (see FIG. 7), the agent takes longer to learn the open-door skill compared to the others. Previous multi-task learning work has proposed several approaches mitigating this problem, albeit in a multi-task pareto-optimal setting. Aspects of the present invention explore using one such recently proposed multi-objective optimization algorithm called Conflict-Averse Gradient descent (CAGrad) to see if this could boost up learning the difficult open-door skill.

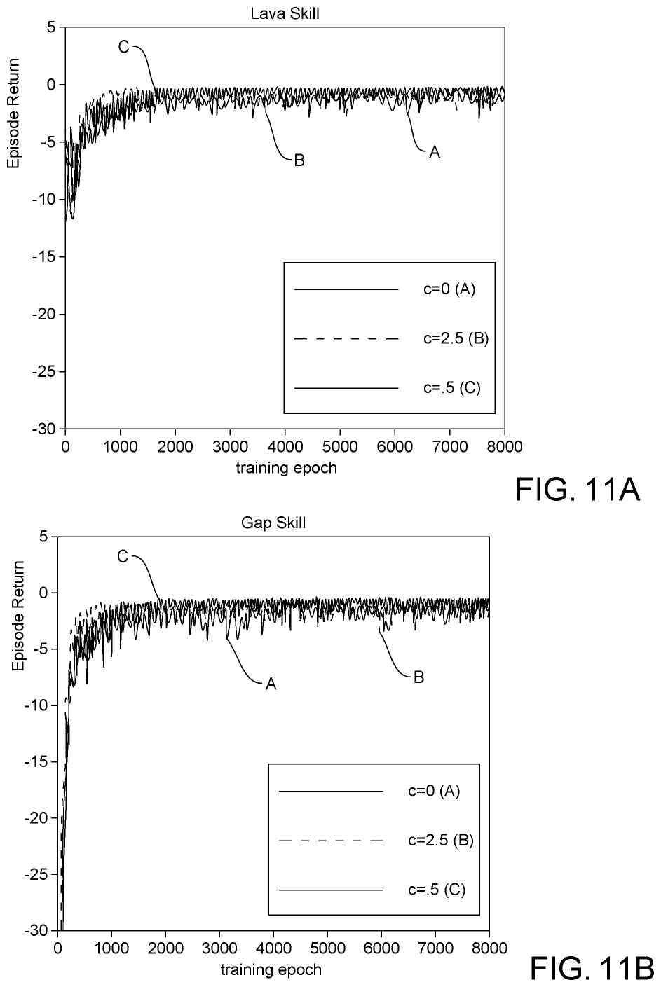

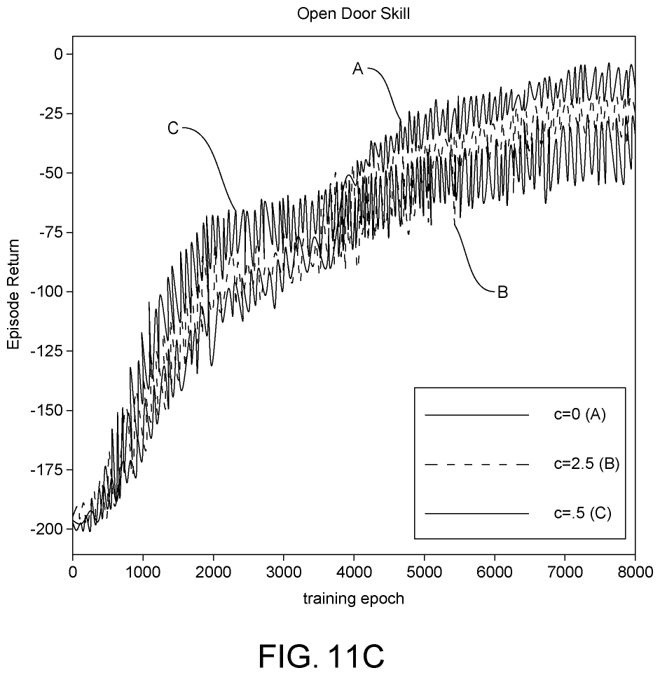

FIGS. 11A through C show statistical results using CAGrad with SSET for different values for the algorithm hyperparameter c∈(0, 1), which controls the extent of minimizing conflicts between losses within a local ball centered around the average gradient. Therefore, setting c=0 reduces to the standard average gradient descent. The plots illustrate that higher values of c boost initial learning but result in lowering the asymptotic value. This can be explained by the fact that, as the local value function targets Qₖ move closer to the global target Q*, the conflicts between event-section losses minimize making conflict optimization redundant. It can be hypothesized that scheduling the parameter c from high values to zero during the course of training would improve the sample complexity and reach optimal asymptotic behavior.

### Lunar Lander and Mujoco Experiments

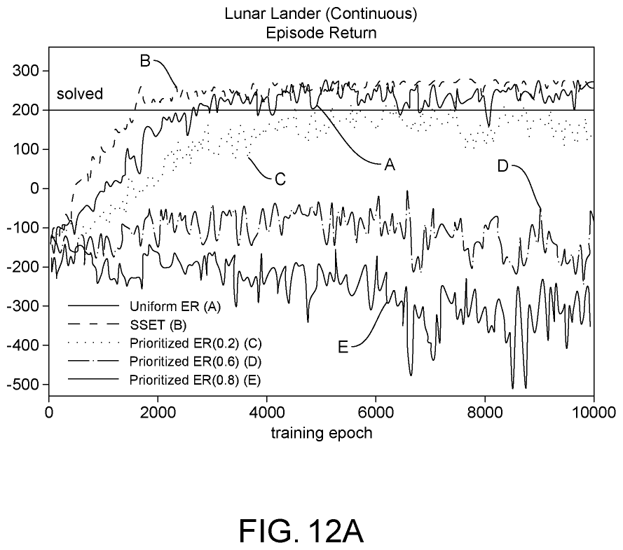

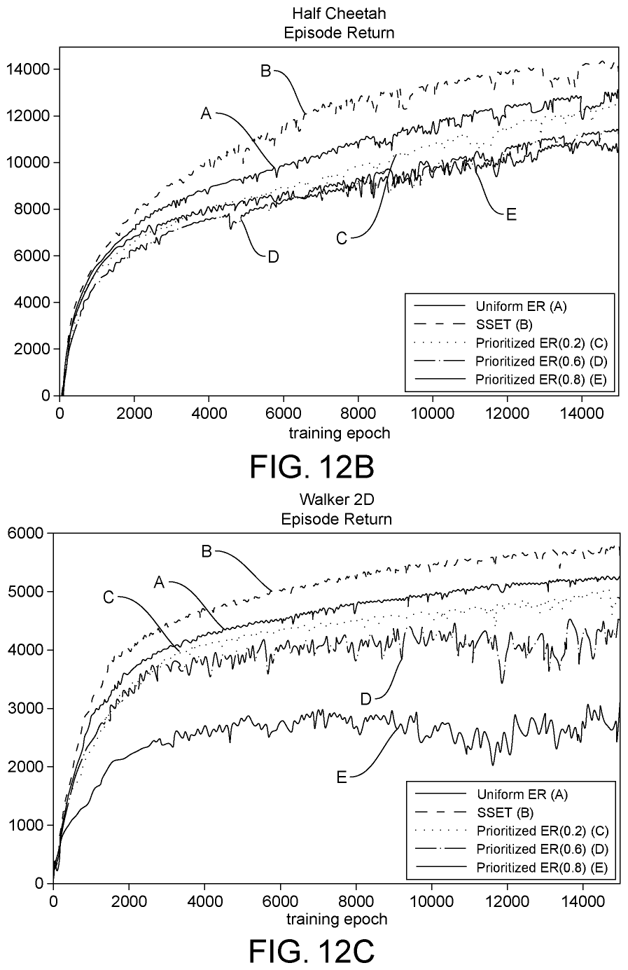

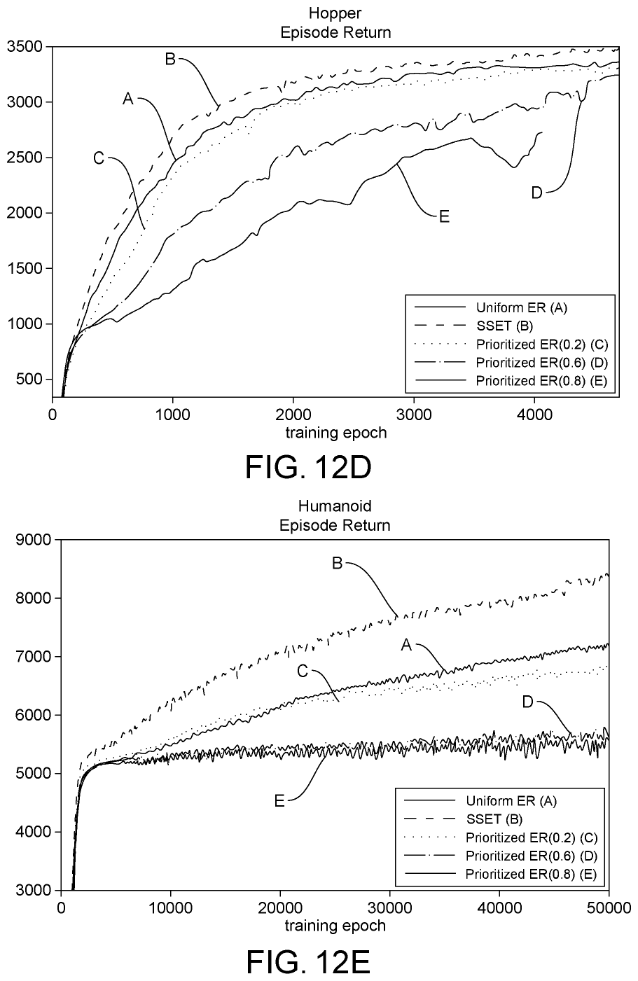

It can now be demonstrated how sample complexity and stability of SSET is improved on several continuous control benchmark tasks (LunarLanderContinuous-v3 and MuJoCo suite defined in OpenAI Gym) that have dense shaping rewards and, in the case of the MuJoCo domains, no pre-defined goal states. For the LunarLander environment, two event conditions were used for SSET with a history length of 200: one that occurs when both lander's legs make contact between the flags, and another when the lander's position is close to the middle of the flags. For the MuJoCo suite, three event conditions were used that occur when the agent receives rewards greater than certain thresholds. Each of those events used history lengths of 200. The thresholds were manually selected for each environment based on the reward bounds. The state-of-the-art SAC RL algorithm was used to compare SSET against uniform experience replay and PER at different priority exponents. FIGS. 12A through 12E show the statistical mean and standard errors of empirical returns computed from 30 randomly seeded episodes evaluated at different epochs during training. The results definitively illustrate SSET improves sample efficiency (by roughly half the number of epochs) and achieves stable policies by bootstraping the salient rewards more rapidly. All four of the MuJoCo domains and LunarLander show similar patterns for SSET. PER performs at-best similar to the uniform experience replay and the performance degrades as the priority exponent is increased. It is suspected that this is because of the high density of shaping rewards, which makes the TD-Errors volatile, making them a bad match for PER.

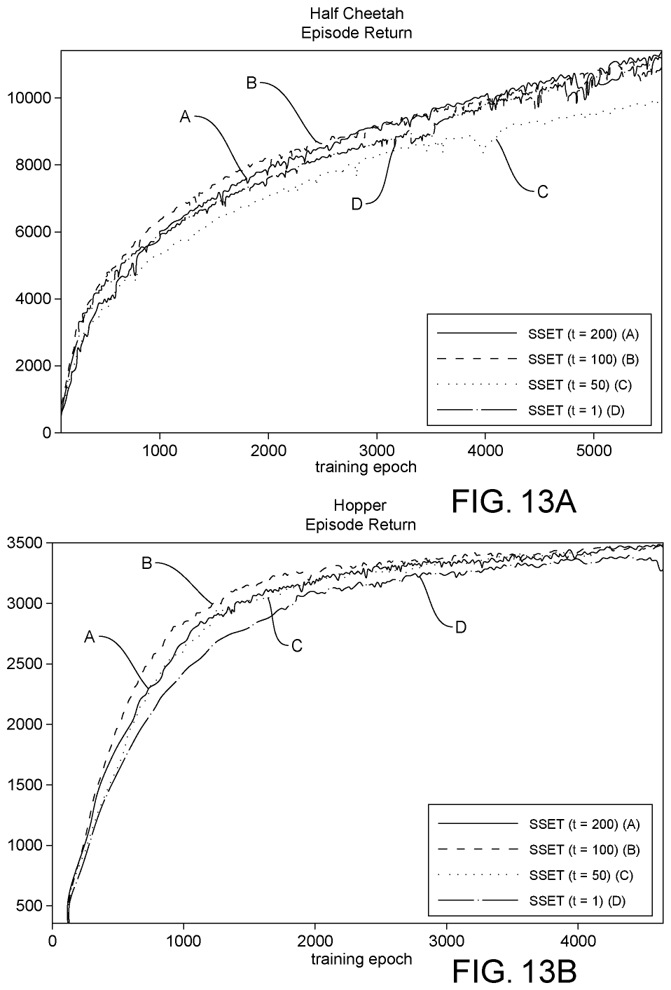

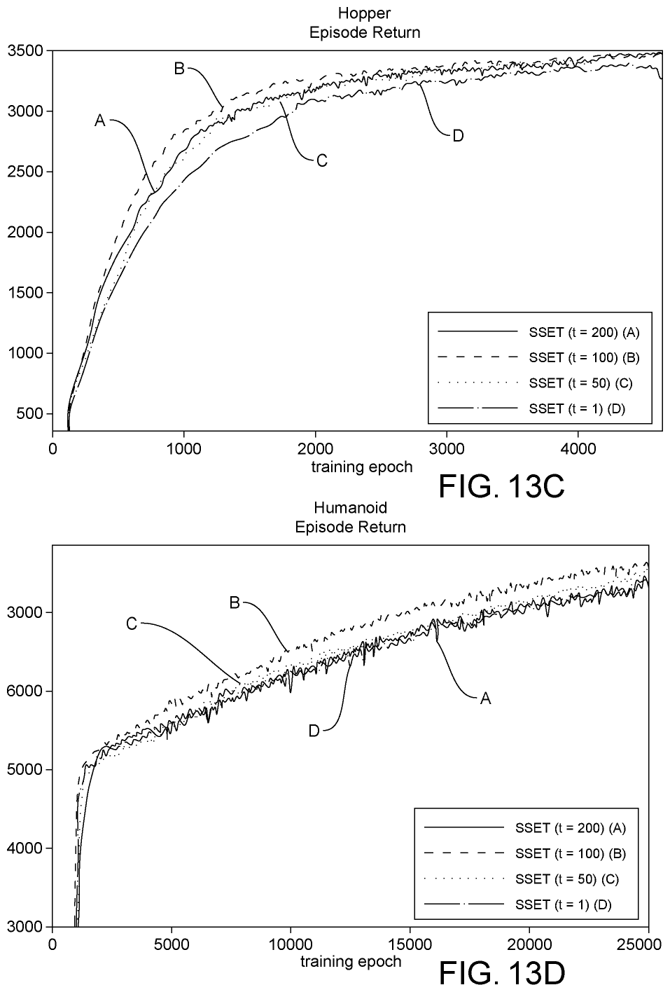

Next, results were shown from an ablation study of changing history lengths in the dense reward MuJoCo domains, similar to the experiments in sparse reward domains discussed above. FIGS. 13A through 13D show the average episodic return (with std-error shown using the shaded regions) during the course of training computed from 30 random seeded runs. In MuJoCo domains, rewards are proportional to the continuous progress made by the agent and with events based on reward thresholds, sample histories for a higher threshold get stored in the tables corresponding to the previous threshold. The results of this study show SSET is again robust to ‘non-optimal’ history lengths, but still show the benefits from using sufficiently long history lengths. These results reinforce the use of longer history lengths in the absence of prior knowledge, and also show the history lengths can be tuned for a peak performance.

### Simulated Car Racing Experiments

Gran Turismo Sport® is a PlayStation® racing simulator that has been previously used as an RL testbed and where an RL system recently outraced human e-sports champions. Previous work used a multi-table ERB based on different initial state conditions, which, in the experiments below, is equivalent to the uniform sampling approach. It was shown that the SSET speeds up convergence when learning to pass another car and mitigates off-course driving in a time-trial scenario.

The environment, features, and training details are the same as the uniform sampling approach, except that the focus is on smaller scenarios to isolate the specific effects of Event Tables. All experiments collected data at 10 Hz from 21 game consoles with one of those typically dedicated to evaluation tasks. The state representation includes hundreds of state features covering aspects such as 3-D velocity, steering angle, a representation of the upcoming course points, and a representation of opponent cars including a [0, 1] measure of the slipstream produced by a car ahead. The Quantile Regression SAC (QR-SAC) algorithm is used with 2048×4 feed-forward neural networks for the value functions and policy. Dropout is used when training the policy network.

Learning the “Slingshot” Pass. In the first experiment, it was demonstrated that SSET's sample complexity benefits in a “slingshot passing” scenario on the Circuit de la Sarthe (Sarthe) track, using a Red Bull X2019 Competition race car, similar to a Formula 1 vehicle. The environment is a relatively straight 1700 meter section of the course with the RL agent always launched behind (in training between [10, 40] meters) one built-in-AI from the game. To succeed, the agent needs to use the opponent's slipstream to accelerate beyond its top open-air speed and use the added momentum to slingshot by the opponent and hold it off to the end of the section. Reward function components incentivize course progress and passing and penalize wall hits, car collisions and off-course driving.

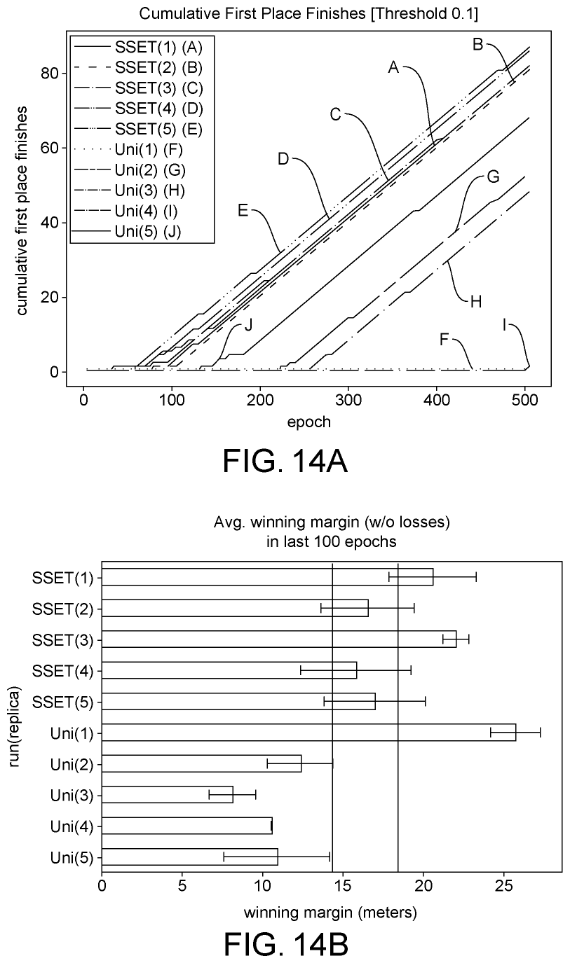

For this task, introduce two events are introduced. A “slipstream” event (with τ=10s) occurs when the agent's slipstream feature is above a threshold (0.7 in this case) and a “won” event (with τ=15s) occurs if the agent ends the section in first place. Both events use κ=η=10%. FIGS. 14A and 14B report the cumulative wins for 5 replicas each of SSET versus a monolithic ERB with uniform sampling, both with total capacities (ΣKᵢ) of 2.5 million steps and sharing common seeds. Policies were evaluated after every 5 epochs with the agent started 35 meters behind the opponent. The uniform sampling runs display high variance, taking anywhere from 70 epochs to 505 epochs to start winning. By contrast, the all 5 SSET runs learn to win consistently by epoch 110. In addition, the SSET runs seem to learn stronger passing skills, with an average winning distance (discarding runs where the agent lost) of 18.4 meters in the last 100 epochs compared to 14.4 meters for uniform sampling. The behavior is somewhat sensitive to the choice of slipstream threshold.

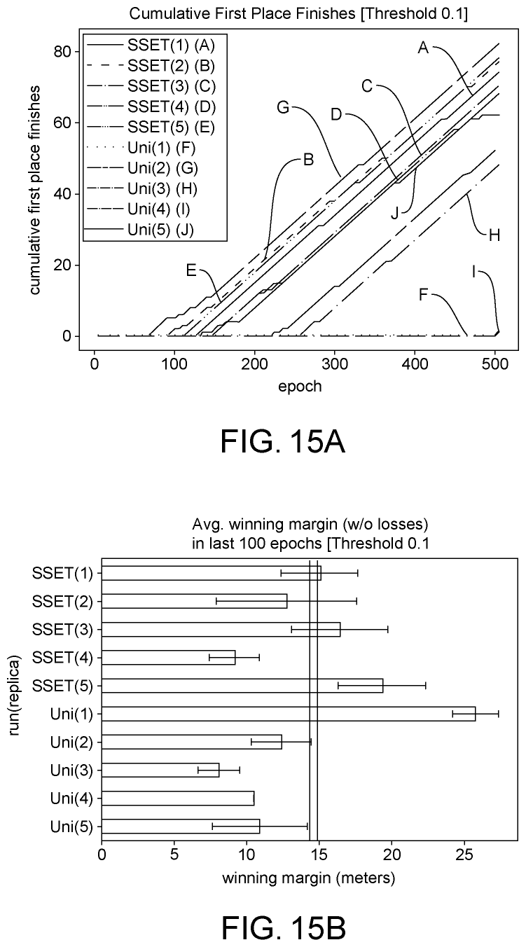

FIGS. 15A and 15B provide results in cases where the slipstream event was triggered by values greater than 0.1, which occurs very commonly when there is an opponent car ahead of the agent within a 60 meter range. Under these conditions, the event is not as informative as the >0.7 event used above. FIGS. 15A and 15B show that, under these conditions, SSET still has better average performance and less variance than uniform sampling, but its performance is not as good as the results in FIGS. 14A and 14B.

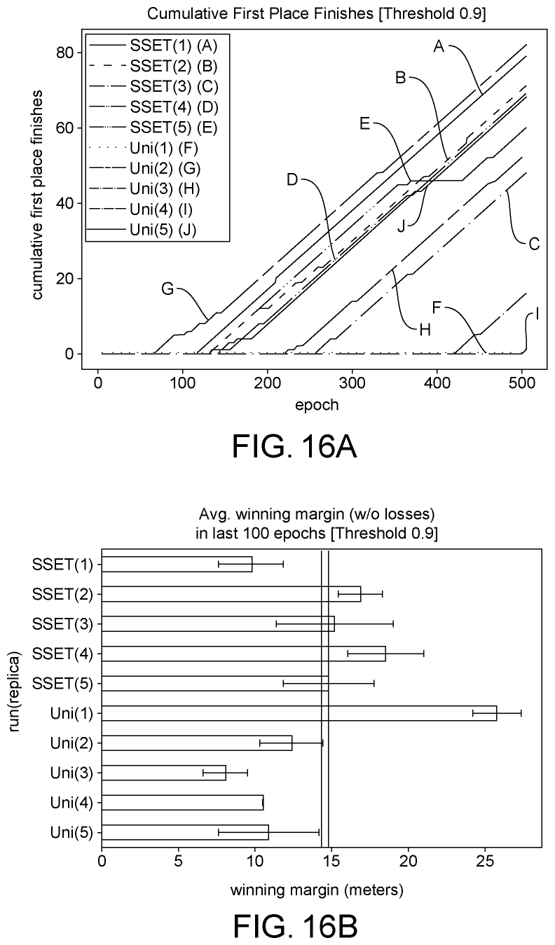

FIGS. 16A and 16B illustrate results when a value greater than 0.9 was needed to trigger the event. This event requires significant exploration to trigger the event early in learning, since the agent must be very close to the car ahead to achieve such a value. Under these conditions, the variance of SSET increases significantly as the time it takes for the events to aid in learning is highly dependent on early exploration. However, SSET's variance is still lower than the uniform sampling approach and SSET tends to win earlier and by a slightly larger margin.

Overall these results indicate that SSET is robust to events that happen frequently or (at the other extreme) are hard to find in early learning. SSET fares no worse than uniform sampling in these cases, though not as well as when using better chosen events.

Remembering to Stay On Course. An experiment is now presented on maintaining multiple skills in a time-trial (solo car) setting on the full Lago Maggiore GP (Maggiore) track using a Porsche 911. Only the time-trial reward components were used. The agent is tasked with running fast laps as well as avoiding off-course penalties. As learning progresses, off-course events become very scarce compared to the roughly 1200 steps an agent takes per lap. Consequently, learned behavior with a monolithic ERB and uniform sampling oscillates: policies may not go off course for several epochs, then “forget” the potential penalty and shift to a policy that cuts corners, and the cycle repeats.

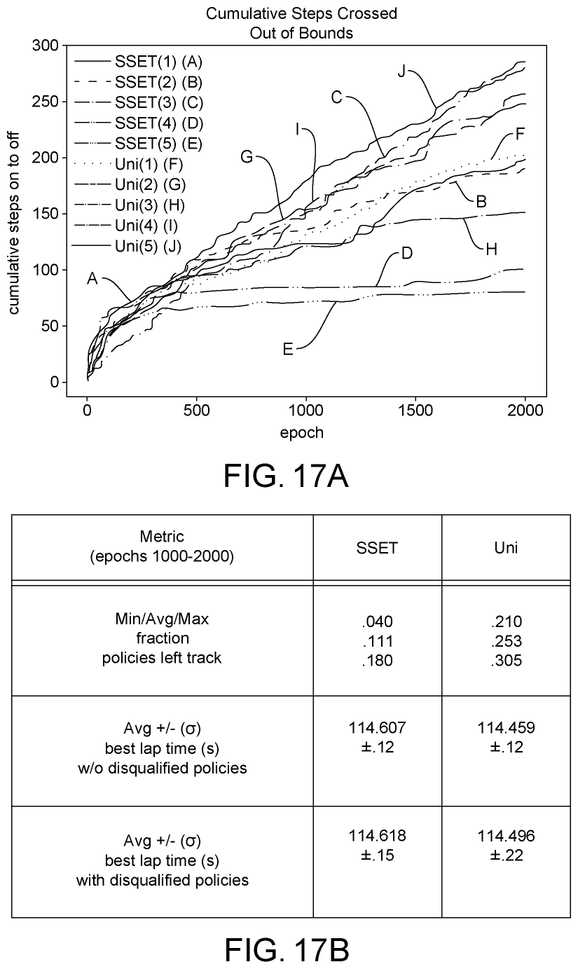

To retain consistent on-track behavior, SSET was used with a re-establish event that occurs if an agent returns to the track for 2 seconds after having left the course and use a history length of 7 seconds (roughly the half-life of the agent's horizon) to capture the full sub-trajectory of leaving and returning to the course. η and κ were set to 1% and an ERB of total capacity 10-million was used. It should be noted that this is an extension of the formal event spec definition since the event condition here is based on a history of states, not just s′. The results of this approach (blue labeled lines in FIG. 17A) show the oscillating behavior is replaced by consistent on-course laps, with 88.9% of SSET policies (up from 74.7% of uniform sampling policies) incurring no penalties after epoch 1000. Notably, the worst off-course percentage for the SSET runs is still better than the best percentage with uniform sampling. The minimum (out of 3 in each eval) lap times averaged across later epochs are also within 0.15 seconds. A second set of 5 runs using a is reestablish requirement with τ=5s achieved virtually the same results (86.9% of policies on course with similar lap times). Thus, in a highly realistic driving simulator with a deep neural network, SSET mitigates catastrophic forgetting and balances learning of multiple skills, echoing the results on MiniGrid domains, discussed above.

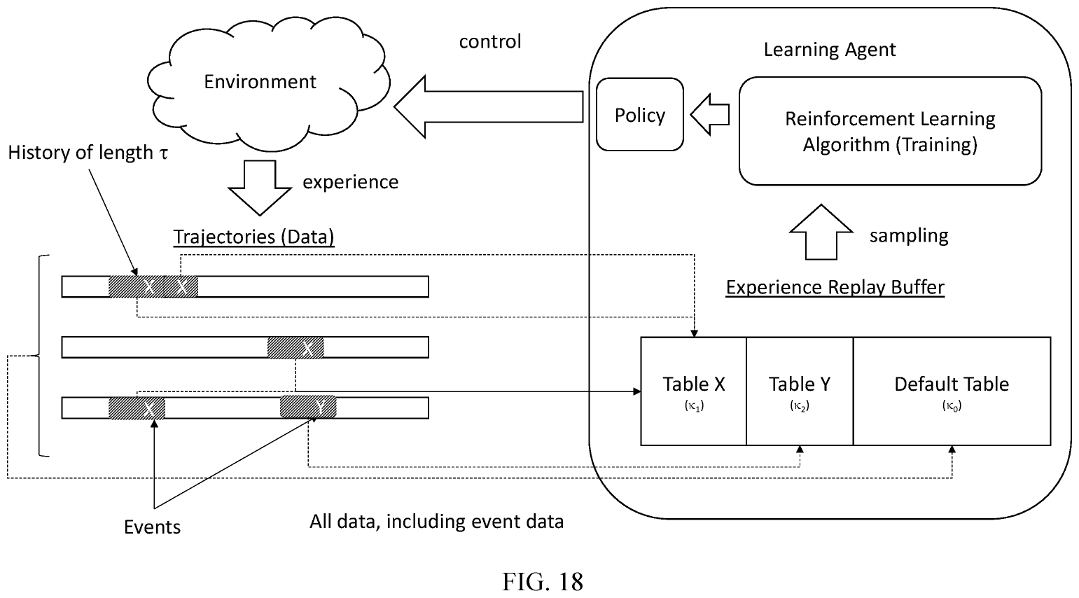

FIG. 18 illustrates the concept of event tables from a storage perspective, where, when an artificial agent encounters an “event”, the agent's history going back for tau timesteps is stored in a specific table, where a “default” table contains duplicates of this event data as well as any data not associated with an event or its corresponding history, where each table has a fixed proportion, kappa, of the overall buffer.

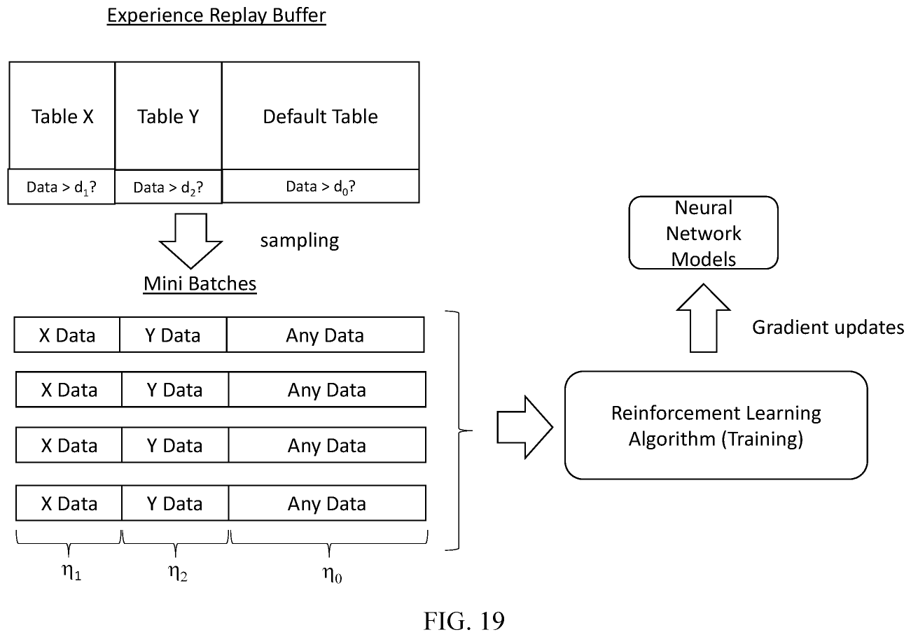

FIG. 19 illustrates the concept of event tables from a sampling perspective, where a learning algorithm samples mini-batches of data from the tables based on fixed proportions (eta) as long as the table has sufficient data (governed by parameter d).

### Recommendations on How to Pick Helpful Events

SSET requires domain knowledge to specify the table partitions and in this regard, is similar to designing potential functions for shaping rewards. In large domains like Mujoco and GT, there are already dense reward structures built into the canonical versions of the environments, so it is difficult to add “yet another reward term” in a meaningful way, but it is quite easy to use SSET and gain benefits from domain knowledge. As for the ease of specifying domain knowledge for SSET, the following guidelines are provided:

(1) For users that don't know their domain well, one can use a “goal” event (see mini-grid experiments, above) or in a non-goal environment, use reward-threshold events (see Mujoco experiments, above) with a fairly long history and reap benefits, even without understanding the true subgoals.

(2) Even if the events are poorly chosen, the technique usually does only as badly as uniform sampling. The cases where it would actually hinder performance are relatively pathological (i.e., using the majority of the buffer for incorrect events) and are easily avoidable in practice by setting reasonable caps on the event table sizes (say no more than 30% total as indicated in FIGS. 5A through 5E with table size experiments with bad events).

(3) Event Tables in SSET only require unsigned integer indices pointing to the data that is already stored in the main buffer. The additional memory footprint expands with the number of tables times their sizes. The publicly available Reverb package already implements this data structure efficiently.

Beyond these guidelines for using user-specified events, the topic of learning a helpful set of events online is an open, but intriguing question. The difficulty in identifying events with no background knowledge is that by Definition 4, events correspond to states that are most likely on optimal trajectories, so in the extreme case knowing the perfect set of events means knowing the optimal policy's state distribution. However, in cases where some model information is known, subgoal discovery methods could be used to propose events. One could also over-specify a large number of events and attempt to learn the weights (η and κ) online, though the current work does not guarantee the convergence of such a meta-learner.

### Summary

Event Tables and SSET algorithm is introduced to improve the sample complexity and stability of off-policy RL algorithms. The theoretical results quantify the potential speedups and lend guidance for choosing event conditions. Experiments in MiniGrid, standard RL benchmarks, and Gran Turismo Sport® show the benefits of SSET over monolithic ERBs or other prioritization schemes. Furthermore, combining TD-error PER or reward shaping on top of SSET led to further improvements in sample complexity and stability.

### Definitions, Lemmas, Propositions Used Above

In this section, sufficient conditions are proven for the improvement of convergence speed using Event Tables and SSET. Specifically, it can be shown that the more correlated events are with optimal behavior, the larger the expected improvement. To ground the analysis and make use of existing results, tabular Q-learning with a target function is used. One can start from known finite-time convergence results in this setting. Specifically, Theorem 1 computes the lower bound of sample complexity (N) for learning an ε-optimal solution using an iterative tabular Q-learning algorithm with target networks (Algorithm 2). It can be shown that the lower bound of the sample complexity for achieving ε-optimal behavior is reduced by using event tables for sampling (Theorem 1).

The steps taken from the known result in the uniform sampling case to the new theorem are as follows. The state probability distribution (density) can be defined following a given policy to a finite horizon from an initial state and that can be used to define the state density disparity to the optimal policy (Definitions 2-3). Then, event conditions can be formally defined (Definition 4) on the states with low optimal-policy disparity or final states of the optimal policy. This definition can be extended to event sections and their corresponding tables that include sufficient history to (on expectation) reach back to a previous event or initial state (Definitions 5-6). Then, the over-sampling of experience in the event tables is quantified (Lemma 1) and the convergence rate is derived (Prop. 3) and bias correction procedure (Lemma 2). Finally, it can be shown that the resulting convergence bound is an improvement over uniform sampling (Theorem 1).

Algorithm 2: Target Q-learning using
an experience replay buffer B

//input: outer loop iteration number K, inner loop iteration number I,
initialization Q₀, step-sizes αₜ.
//output: Q_{K}

| | |
|---|---|
| 1 | for k = 0 to K − 1 do |
| | // outer loop |
| 2 | Q_{k,0} ← Qₖ |
| 3 | for i = 0 to I − 1 do |
| | // inner loop |
| 4 | (s, a, r, s′) ~ B // randomly sample a transition |
| 5 | Q_{k,i+1}(s, a) = Q_{k,i}(s, a) + αᵢ(r + γ max_{a′} Qₖ(s′, a′) − Q_{k,i}(s, |

a)) // update

| | |
|---|---|
| 6 | end |
| 7 | Qₖ₊₁ ← Q_{k,I} // refresh target |
| 8 | end |

First, a general overview of the base algorithm and the existing results is provided.

Assumptions: Throughout the analysis it is considered a finite discrete episodic MDP M=(S, A, P, R, T, γ), where S and A are finite and discrete state and action spaces, P is the state transition probability and R is a bounded reward function, such that r(s, a)∈[0, 1], ∀(s, a)∈S×A, T is the length of each episode and γ∈(0, 1) is the discount factor. It is assumed for simplicity in notation that any terminal state traps the agent until time step T. It is assumed that the agent takes actions using a fixed stochastic behavior policy πb): S×A→[0, 1], such that it can visit every state and execute every action with a non-zero probability within the T time-step horizon. π* : S×A→[0, 1] can be denoted to be an optimal policy of the MDP, such that its state-action value function is optimal Q^{π*}(s, a)=max_{π}Q^{π}(s, a), ∀(s, a)∈S×A. Again for simplicity in notation, it can be assumed that the event-tables are sampled uniformly with a total sampling probability denoted by η=Σᵢ₌₁ⁿnᵢ (=η/n) (see Algorithm 1). The sampling probability of the default-table is η₀=1 −η.

Let T:R^{|S∥A|}→R^{|S∥A|} define the Bellman operator

$$T {Q}_{k} ( S , a ) = {𝔼}_{{s}^{′} \sim P ( - \vert s , a )} [ r ( s , a ) + γ {max}_{{a}^{′}} {Q}_{k} ( {s}^{′} , {a}^{′} ) \} .$$

Q-learning using a target-network Qₖ and an experience replay buffer B can be viewed as minimizing the following loss function:

$${min}_{Q ∈ {R}^{\vert S \vert \vert A \vert}} l ( Q ; {Q}_{k} , B ) = \frac{1}{2} \begin{matrix}𝔼 \\ ( s , a , r , \cdot ) \sim B\end{matrix} [ {( \begin{matrix}𝔼 \\ {s}^{′} \sim P ( \cdot \vert s , a \}\end{matrix} [ r ( s , a ) + {max}_{{a}^{′}} {Q}_{k} ( {s}^{′} , {1}^{′} ) ] - Q ( s , a ) )}^{2} ] \qquad ( 1 )$$

For a given buffer B generated using the fixed behavior policy π^{b}, constants can be defined

$${C}_{B} := {min}_{s ∈ S , a ∈ A} P ( ( s , a , \cdot , \cdot ) ∼ B )$$

$${L}_{B} := {max}_{s ∈ S , a ∈ A} P ( ( s , a , \cdot , \cdot ) ∼ B$$

Here, C_{B} and L_{B} denote the minimum and the maximum probability that a state-action pair (s, a) is sampled from the buffer. From the assumptions, C_{B}>0.

Carrying out N steps of SGD optimizing Eq. 1, one can get to an approximation of TQₖ with a certain error bound [symbol] [∥Qₖ₊₁−TQₖ∥]≤εₖ₊₁, which then accumulates across outer iterations over k.

Proposition 1. Consider an MDP with Q₀=0, C_{B}>0, αₜ=α/(λ+t), where α=2/C_{B} and λ=(13γ²L_{B})/(2c_{B}²). The minimum number of samples required to achieve an ε-optimal solution [symbol] [∥Q_{K}−Q*∥∞]≤ε using Algorithm 2 is given by

$${N}^{B , K} = \frac{832 {γ}^{2}}{{( 1 - γ )}^{5} {g}^{2}} log ( \frac{4}{( 1 - γ ) ε} ) \frac{{L}_{B}}{{C}_{B}^{3}} .$$

It can be shown that SSET can decrease this bound when the events are correlated with an optimal policy and histories are sufficiently long. To quantify these conditions, the following definitions of optimal trajectories can be used and their state densities induced by various policies.

Definition 1. Trajectory: A trajectory Γₛ_{ᵢ}_{,s}_{ⱼ}^{π} of the MDP M can be defined as a temporal sequence of transition tuples

Γₛ_{ᵢ}_{,s}_{ⱼ}^{π}={(sₖ,aₖ,rₖ,sₖ₊₁)|sₖ₊₁˜P(·|sₖ,aₖ˜π(·|sₖ)),rₖ˜ [symbol] ₐₖ^{s}^{ₖ}^{,s}^{ₖ₊₁},∀ₖ∈[i,j−1])}.

For simplicity, |Γₛ_{ᵢ}_{,s}_{ⱼ}^{π}| denotes the length or the number of transitions of the trajectory.

Definition 2. State Density: One can define ρ^{π,s0,K}:S→[0, 1] as the state probability distribution following any policy π for the MDP with the initial state so over a finite time horizon K

$${ρ}^{π , {s}_{0} , K} ( s ) = \frac{1}{C} {Σ}_{k = 0}^{K} P ( {s}_{k} = s \vert π , {s}_{0 )} . \qquad ( 2 )$$

C enforces the constraint 1^{T}τ̅^{π,s}^{_{0,K}}=1 to make ρ^{π,s}^{₀}^{,K} a probability distribution, where ρ̅^{π,s}^{₀}^{,K}=[ρ^{π,s}^{₀}^{,K}(s₁, . . . , ρ^{π,s}^{₀}^{,K}(s_{N})]^{T}∈ [symbol] ^{N}.

Definition 3. State Density Disparity from Optimal: One can define \tilde{ρ}^{π,s}^{₀}^{,K}: S→[−1, 1] as the difference in the state density following any policy π compared to an optimal-policy π* for the MDP with the initial state so over a finite time horizon K

\tilde{ρ}^{π,s}^{₀}^{,K}(s)=ρ^{π*,s}^{₀}^{,K}(s)−ρ^{π,s}^{₀}^{,K}(s) (3)

An event condition can be formally defined as ω:S→{0, 1}, which is the core concept of the SSET algorithm according to embodiments of the present invention. An event occurs when an agent enters a state that satisfies the event condition, which implicitly defines a set of event states: I_{[s∈Sωi}]. Intuitively, good event conditions should be aligned with the optimal policy and also act as waypoints linking initial and final states visited by the optimal policy. Therefore, final states visited by the optimal policy should also satisfy at least one event condition.

Definition 4. Event condition: Let I denote the initial state distribution of the episodic MDP with the episode length T. For a given threshold μ∈(0, 1), a collection of event sets can be defined as S^{ω}={S^{ω1}, . . . , S^{ωn}}, such that ∀si∈S^{ωi}∃sⱼ∈I∪S^{ωj} where the following conditions are true:

either \tilde{ρ}^{π}^{^{b}}^{,s,j,T}(sᵢ)≥Δ=(1−μ) (4)

or |Γ_{s∈I,s}_{ᵢ}^{π*}|=T (5)

An event condition can be defined as ωᵢ:S→{0, 1}, ∀i∈[1, n] such that ωᵢ(s)=I_{[s∈Sωi]}.

Intuitively Condition (4) covers states that are significantly (based on μ) more likely under the optimal policy than under π^{b}. Condition (5) covers terminal states visited by the optimal policy in case they are not satisfied under Condition (4). It should be noted that the definition above could cover a large amount of the state space in highly stochastic domains. Therefore, Theorem 1 filters the set further to focus on higher probability states without significant degradation to the overall sample complexity.

For simplicity in the notation used in the proofs, an event section can be denoted as E^{ωi} as a set of states whose state density disparity from the optimal policy is less than (or equal to) Δ. Intuitively, these are the states from which the agent can easily reach the event states.

Definition 5. Event Section: One can define an event section E° ′ as

E^{ω}^{ᵢ}={s|sup(s′∈S){\tilde{p}^{π}^{^{b}}^{,s′,T}(si),∀Si∈S^{ω}^{ᵢ}}=Δ}=.

Proposition 2. For a given μ, ∃S^{ω} such that all initial states of the MDP I, the event states SS^{ω}^{_{∀i}}, and the optimal terminal states {s∥Γₛ_{₀}_{∈I,s}^{π*}|=T} belong to at least one event section E^{ω}.

Proof. First, one can consider the case where, for a given μ, Condition (4) does not hold for any s E S. From Def. 4, S^{ω} contains only a single event-set that includes all the optimal terminal states S^{ωterm}={s∥Γₛ_{₀}_{∈I,s}^{π*}|=T}. Therefore, from Def. 5, all initial states belong to the event section ∃^{ωItem}, and hence the result is true for this case.

Now for the case where there are non-zero number of event-sets that satisfy Condition (4), it follows that the event states belong to either the event section where Condition (4) is true or the terminal E^{ωItem}. From the definition of events, an event table can be defined that stores these experiences that lead to them.

Definition 6. Event Table: An event table B^{vi} for event spec vᵢ= [symbol] ωi,τᵢ [symbol] , denotes an experience replay buffer, which is a multiset (a set with repeated elements) of transitions from trajectories of a given maximum length τᵢ such that

$$⋃ \{ ( s , a , r , {s}^{′} ) \} ( s , a , r , {s}^{′} ) ∈ {Γ}_{{s}_{i} , {s}^{{ω}_{i}}}^{{π}^{b}} , \vert {Γ}_{{s}_{i} , {s}^{{ω}_{i}}}^{{π}^{b}} \vert \leq {τ}_{i} , ∀ {s}^{{ω}_{i}} ∈ {S}^{{ω}_{i}} \} . \qquad ( 6 )$$

Using the above definitions, the likelihood of sampling any particular state from an ERB that contains both event tables and a default table B⁰ can be analyzed based on fixed sampling probabilities of the event tables (as used in Algorithm 1). The following lemma quantifies the over-sampling of experiences in the event tables.

Lemma 1. Let B^{v}=═_{∀i∈[1,n]}B^{v} denote the union events table and B⁰ denote the default table that contains all the transitions collected following a fixed behavior policy π^{b}·s˜^{η}B^{v}∪B⁰ denotes a weighted sampling (0<η<1) of a transition tuple (s, ·, ·, ·) between the event and the default tables. For any event-spec vᵢ,

$$if {τ}_{t} \leq \frac{{( 1 - η )}^{m}}{( m + 1 ) n μ} ,$$

$$then P ( s {∼}^{η} {B}^{ν} ⋃ {B}^{0} ) \geq {( 1 - η )}^{- m} P ( s ∼ {B}^{0} ) , ∀ ( s , \cdot , \cdot , \cdot ) ∈ {B}^{{ν}_{i}} , m ∈ {ℤ}^{0 +} .$$

Proof Expanding the weighted sampling probability, one has

$$\begin{matrix}P ( s {\sim}^{η} {B}^{ν} ⋃ {B}^{0} ) = η P ( s ∼ {B}^{ν} ) + ( 1 - η ) P ( s ∼ {B}^{0} ) \\ = η P ( s ∼ {B}^{ν} ) + ( 1 - η ) P ( s ∼ {B}^{0} ) - \frac{P ( s ∼ {B}^{0} )}{{( 1 - η )}^{m}} + \\ \frac{P ( s ∼ {B}^{0} )}{{( 1 - η )}^{m}} \\ = η ( P ( s ∼ {B}^{ν} ) - \frac{1 - {( 1 - η )}^{m + 1}}{{η ( 1 - η )}^{m}} P ( s ∼ {B}^{0} ) ) + \\ {( 1 - η )}^{- m} P ( s ∼ {B}^{0} ) \\ = η ( P ( s ∼ {B}^{ν} ) - \frac{{\sum }_{k = 0}^{m} {( 1 - η )}^{k}}{{( 1 - η )}^{m}} P ( s ∼ {B}^{0} ) ) + \\ {( 1 - η )}^{- m} P ( s ∼ {B}^{0} ) \\ \geq η ( P ( s ∼ {B}^{ν} ) - \frac{m + 1}{{( 1 - η )}^{m}} P ( s ∼ {B}^{0} ) ) + \\ {( 1 - η )}^{- m} P ( s ∼ {B}^{0} )\end{matrix} \qquad ( 7 )$$

$$( ∵ ( 1 - η ) < 1 )$$

$${{=}^{∵ ( s , \cdot , \cdot , \cdot ) ∈ {B}^{{ν}_{i}}} η}_{Def . 6} {\sum }_{k = 0}^{{τ}_{i}} P ( {s}_{{τ}_{i} - k} = s \vert {s}_{{τ}_{i}} = {s}^{{ω}_{i}} , {π}^{b} ) [ P ( {s}_{{τ}_{i}} = {s}^{{ω}_{i}} \vert {B}^{ν} ) - \frac{m + 1}{{( 1 - η )}^{m}} P ( {s}_{{τ}_{i}} = {s}^{{ω}_{i}} \vert {B}^{0} ) ] + {( 1 - η )}^{- m} P ( s ∼ {B}^{0} ) ,$$

$${s}^{{ω}_{i}} ∈ {S}^{{ω}_{i}} .$$

B^{vi} contains only trajectories of length ≤τᵢ that all lead to s^{ωi}∈S^{ωi}. Therefore, P(s_{τi}=s^{ωi}|B^{vi})≥1/τᵢ. Given the event-table sampling algorithm described above (with the assumption that a table is uniformly sampled), one has P(s_{τi}=s^{ωi}|B^{v})=P(ωi˜{ωi,∀i}) P(s_{τi}=s^{ωi}|B^{vi})≥1/nτᵢ. For the event section E^{ωi} from Def 4 and ρ^{π*,·,T}(S^{ωi})≤1, therefore P(s_{τi}=s^{ωi}|B^{v})≤μ. Substituting in Eq. 7, one gets

$$\begin{matrix}P ( s {∼}^{η} {B}^{ν} ⋃ {B}^{0} ) \geq η {\sum }_{k = 0}^{{τ}_{i}} P ( {s}_{{τ}_{i} - k} = s \vert {s}_{{τ}_{i}} = {s}^{{ω}_{i}} , {π}^{b} ) [ \frac{1}{n {τ}_{i}} - \frac{m + 1}{{( 1 - η )}^{m}} μ ] + \\ {( 1 - η )}^{- m} P ( s ∼ {B}^{0} ) \\ \geq {( 1 - η )}^{- m} P ( s ∼ {B}^{0} )\end{matrix}$$

$$∵ \frac{1}{n {τ}_{i}} \geq \frac{m + 1}{{( 1 - η )}^{m}} μ$$

Typically, the threshold μ is very small as the state density following the behavior policy drops exponentially with the number of forward time steps. With small values of μ, next it can be shown that m>1, thereby quantifying the over-sampling of experiences in positive powers of 1/(1−η).

Proposition 3. m is asymptotically convergent to −ln(τᵢμ)−ln ln(τᵢμ)+o(1) as μ→0.

Proof Rearranging the condition in Lemma 1 for equality

$${e}^{( m + 1 ) ln ( 1 - η )} = \frac{( 1 - η ) n {τ}_{i} μ}{ln ( 1 - η )} ( m + 1 ) ln ( 1 - η )$$

Setting a=1/(1−η), b=|nu|τᵢμ/a, x=(m+1) and y=(x ln a), the equation reduces to ye^{y}=ln a/b. The solution to this equation is the Lambert W function W₀ ((ln a)/b)>0

$$m = \frac{1}{ln ( a )} {W}_{0} ( \frac{a ln ( a )}{n {τ}_{i} μ} ) - 1. \qquad ( 8 )$$

W₀(x) is asymptotic to ln x−ln ln x+o(1) for large values of x. With small values of μ, one gets

m=−ln(τᵢu)−ln ln(τᵢu)+o(1). (9)

Sampling using event-tables may introduce a bias as it can change the expected value of the stochastic Bellman operator

$$T {Q}_{k} ( s , a ) = {E}_{{s}^{′} \sim P ( \cdot \vert s , a )} [ r ( s , a ) + γ {max}_{{a}^{′}} {Q}_{k} ( {s}^{′} , {a}^{′} ) ]$$

for the (s, a) pair whose next state has a finite probability to either belong to the event-tables or not. This bias can be corrected by computing weights for weighted importance sampling similarly to PER.

Lemma 2. Bias introduced by the weighted sampling s˜ⁿB^{v}∪B⁰ between the event and the default tables is given by

$$w ( s , a ) = \{ \begin{matrix}1 - η {\sum }_{{s}^{′} ∈ S} P ( ( s , a , \cdot , {s}^{′} ) ∉ {B}^{ν} \vert s , a ) , if ( s , a , \cdot , \cdot ) ∈ {B}^{ν} \\ \frac{1}{1 - η} , otherwise\end{matrix} .$$

Proof. Event tables construction (see Algorithm 1) prioritizes transitions that are in either of the event buffers over the ones that are out. Given an (s, a) pair, the transitions that are not present in any of the event tables are sampled from the default table with a probability of 1−η. Therefore, the remainder nΣ_{s′∈S}P(s′∉B^{v}|s, a) is adjusted among the probabilities of transitions in the event-buffers. The correction weight that is needed is 1−ηΣ_{s′∈S}P(s′∉B^{v}|s, a). For the transitions that are not in the event buffers, only a scaled correction of (1−η) is required.

Now that the oversampling and bias-corrections of event histories is quantified, the main theorem is stated, showing that with sufficient history and events that are correlated with optimal behavior, the convergence speed of Q-learning to an optimal policy is improved over the monolithic ERB (B=)B⁰ sample complexity (N^{B,K}).

Theorem 1. Let S^{f} denote the set of states such that the sampled optimal trajectories starting from those states, are contained in the combined event-buffer with a probability greater than p̅∈(0, 1]

S^{f}={s|P(Γ_{s,s′}^{π*}⊂ [symbol] ^{v})≥p̅}.

Under the conditions of Prop. 1 and if τ_{∀i∈[1,n]}≤((1−η)^{m}/(m+1)ημ), then

P(N [symbol] ^{^{v}}^{∪} [symbol] ^{,K}≤(1−η)^{2m}N [symbol] ^{,K})≥p̅,∀s∈S^{f},m∈ [symbol] ⁰⁺.

Proof Let M^{s}^{^{f}}=(S^{f}, A, P, R) be a reduced MDP of M with the initial, event and terminal states in S^{f} (Prop. 2). With the bias correction applied from Lemma 2,

$${π}^{* , {M}^{{S}^{f}}} ( s ) = {π}^{* , M} ( s ) , ∀ s ∈ {S}_{f} .$$

$$With {c}^{B ν} {⋃}^{B 0} := {min}_{s ∈ {S}^{f} , a ∈ A} P ( ( s , a , \cdot , \cdot ) ∼ {B}^{ν} ⋃ {B}^{0} )$$

$$and {L}^{B ν} {⋃}^{B 0} := {max}_{s ∈ {S}^{f} , a ∈ A} P ( ( s , a , \cdot , \cdot ) ∼ {B}^{ν} ⋃ {B}^{0} )$$

as constants the result of the theorem then follows from using Lemma 1 in Prop. 1 for MDP M^{s}^{^{f}} using event-tables for experience replay.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A computer-implemented method comprising:
partitioning an experience replay buffer for a reinforcement learning agent into event tables based on event conditions and history lengths, wherein
each table contains data where a corresponding event condition was true or states that preceded the corresponding event condition within the given history length.

2. The method of claim 1, where the experience replay buffer includes a default table that holds all incoming data.

3. The method of claim 1, where the event conditions are based on histories and not just a single state.

4. The method of claim 1, where each event table has a specified capacity in the experience replay buffer proportional to an overall size of the experience replay buffer.

5. The method of claim 1, where each table has a specified sampling probability.

6. The method of claim 1, wherein a mapping from the event conditions to the event tables is surjective, with multiple ones of the event conditions funneling data into the same one of the event tables.

7. The method of claim 1, where the event conditions represent a handling or manipulation of objects by an artificial agent.

8. The method of claim 1, wherein, in a car racing simulator, the event conditions are based on drafting in a car's slipstream, winning a race, recovering from going off-course, and racing incidents.

9. The method of claim 1, wherein, in continuous control problems that already have rich reward signals, event conditions are based on exceeding thresholds in immediate rewards from a state.

10. The method of claim 7, wherein at least some of the event conditions are suboptimal and designed to help the artificial agent retain memory of, and avoid, adverse outcomes.

11. A computer-implemented method comprising:
partitioning an experience replay buffer for a reinforcement learning agent into event tables based on event conditions and history lengths; and
permitting stratified sampling from the event tables (SSET) for utilizing the event tables with a reinforcement learning system.

12. The method of claim 11, further comprising blocking sampling from one of the event tables until it has sufficient data.

13. The method of claim 11, further comprising determining a bias correction term for stochastic environments.

14. The method of claim 11, further comprising applying a prioritization scheme inside each of the event tables while sampling.

15. The method of claim 11, further comprising multi-task training to balance gradient updates to respect data from each of the event tables.

16. A method of partitioning an experience replay buffer for a reinforcement learning agent, comprising:
determining at least one event condition;
determining at least one preceding state indicating a state preceding the event condition within a history length; and
partitioning the experience replay buffer into at least one event table based on the at least one event condition and the history length,
wherein each event table contains data where a corresponding event condition was true or a preceding state.

17. The computer-implemented method of claim 16, further comprising permitting stratified sampling from the event tables (SSET) for utilizing the event tables with a reinforcement learning system.

18. The method of claim 17, further comprising blocking sampling from one of the event tables until it has sufficient data.

19. The method of claim 16, where the experience replay buffer includes a default table that holds all incoming data.
